(19) United States
(12) Patent Application Publication
(10) Pub. No.: US 2013/0034759 A1
(43) Pub. Date: Feb. 7, 2013

(54) NONAQUEOUS ELECTROLYTIC SOLUTION, NONAQUEOUS ELECTROLYTIC SECONDARY BATTERY, BATTERY PACK, ELECTRONIC DEVICE, ELECTRIC VEHICLE, POWER STORAGE DEVICE, AND POWER SYSTEM

(71) Applicants: Yusuke Funada, Fukushima (JP); Tadahiko Kubota, Kanagawa (JP)

(72) Inventors: Yusuke Funada, Fukushima (JP); Tadahiko Kubota, Kanagawa (JP)

(73) Assignee: SONY CORPORATION, Tokyo (JP)

(21) Appl. No.: 13/559,306

(22) Filed: Jul. 26, 2012

(30) Foreign Application Priority Data
Aug. 5, 2011 (JP) 2011-172218
Feb. 28, 2012 (JP) 2012-042206

(51) Int. Cl. H01M 10/0564; H01M 10/48; H02J 7/00; H01M 2/02

(52) U.S. Cl. 429/90; 429/188; 429/199; 429/200; 429/163; 320/128

(57) ABSTRACT

A nonaqueous electrolytic secondary battery includes: a positive electrode; a negative electrode; and an electrolyte that contains a nonaqueous electrolytic solution, wherein the nonaqueous electrolytic solution contains at least one phosphorus compound selected from the group consisting of phosphine oxide, phosphonic ester, and phosphinic ester, and the phosphine oxide, the phosphonic ester, and the phosphinic ester are phosphorus compounds represented by the following formulae (I), (II), and (III), respectively.

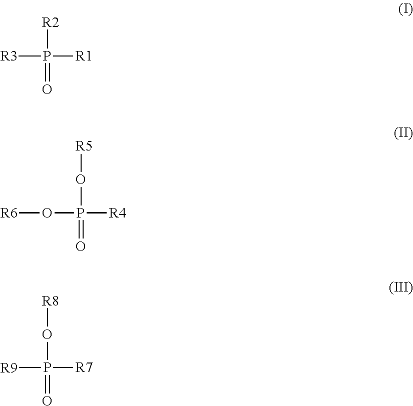

### CROSS REFERENCES TO RELATED APPLICATIONS

The present application claims priority to Japanese Priority Patent Application JP 2011-172218 filed in the Japan Patent Office on Aug. 5, 2011, and Japanese Priority Patent Application JP 2012-042206 filed in the Japan Patent Office on Feb. 28, 2012, the entire content of which is hereby incorporated by reference.

### BACKGROUND

The present application relates to nonaqueous electrolytic solutions, nonaqueous electrolytic secondary batteries, battery packs, electronic devices, electric vehicles, power storage devices, and power systems. Specifically, the present application relates to nonaqueous electrolytic secondary batteries that contain a phosphorus compound in the electrolyte.

There is a strong demand for smaller, lighter, and longer-life portable electronic devices such as camera-integrated VTRs (Video Tape Recorders), cellular phones, and laptop personal computers, which have become widely used in recent years. In this connection, batteries, particularly secondary batteries, which are light and capable of providing high energy density, have been developed as the portable power source of such electronic devices. Particularly, secondary batteries (lithium ion secondary batteries) that take advantage of the storage and release of lithium (Li) for the charge and discharge reaction have been put to a wide range of practical applications for their ability to provide higher energy density compared to nonaqueous electrolytic solution secondary batteries such as lead batteries and nickel cadmium batteries.

In the lithium ion secondary batteries, electrolytes dissolving the electrolyte salt LiPF₆ in carbonate ester nonaqueous solvents such as propylene carbonate and diethyl carbonate are widely used because of high conductivity and potential stability.

However, the spread of the portable electronic devices has created a problem. Specifically, battery characteristics deteriorate as the secondary batteries are often placed in a high-temperature environment during transport or use. This has created the need for the development of an electrolyte and a secondary battery that can provide excellent characteristics not only in a room-temperature environment but in a high-temperature environment.

To this end, techniques are reported that add a phosphorus compound to an electrolytic solution to improve storage characteristics in a high-temperature environment (see, for example, JP-A-2006-236986, JP-A-2007-250191, JP-A-2008-021624, JP-A-2008-066062, JP-A-2008-130528, and JP-A-2009-224258).

### SUMMARY

However, battery characteristics in a high-temperature environment need to be improved further to meet the increasing demand for higher performance secondary batteries.

Accordingly, there is a need for a nonaqueous electrolytic solution, a nonaqueous electrolytic secondary battery, a battery pack, an electronic device, an electric vehicle, a power storage device, and a power system that can provide excellent battery characteristics even in a high-temperature environment.

An embodiment of the present application is directed to a nonaqueous electrolytic secondary battery that includes: a positive electrode; a negative electrode; and an electrolyte that contains a nonaqueous electrolytic solution, wherein the nonaqueous electrolytic solution contains at least one phosphorus compound selected from the group consisting of phosphine oxide, phosphonic ester, and phosphinic ester, and the phosphine oxide, the phosphonic ester, and the phosphinic ester are phosphorus compounds represented by the following formulae (I), (II), and (III), respectively.

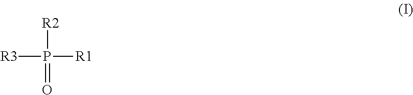

In the formula (I), R1 is an organic group having one or more unsaturated bonds, and the phosphorus and R1 are bonded to each other by a phosphorus-carbon (P—C) bond. R2 and R3 each independently represent a hydrocarbon group of 1 to 20 carbon atoms, or a hydrocarbon group of 1 to 20 carbon atoms whose hydrogen atoms are at least partially replaced with a halogen atom. R1, R2, and R3 are unbound to each other.

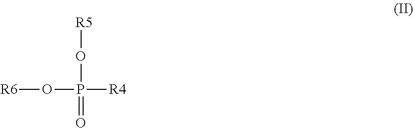

In the formula (II), R4 is an organic group having one or more unsaturated bonds, and the phosphorus and R4 are bonded to each other by a phosphorus-carbon (P—C) bond. R5 and R6 each independently represent a hydrocarbon group of 1 to 20 carbon atoms, or a hydrocarbon group of 1 to 20 carbon atoms whose halogen atoms are at least partially replaced with a halogen atom. R4, R5, and R6 are unbound to each other.

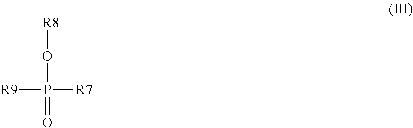

In the formula (III), R7 is an organic group having one or more unsaturated bonds, and the phosphorus and R7 are bonded to each other by a phosphorus-carbon (P—C) bond. R8 and R9 each independently represent a hydrocarbon group of 1 to 20 carbon atoms, or a hydrocarbon group of 1 to 20 carbon atoms whose halogen atoms are at least partially replaced with a halogen atom. R7, R8, and R9 are unbound to each other.

Another embodiment of the present application is directed to a nonaqueous electrolytic solution that includes at least one phosphorus compound selected from the group consisting of phosphine oxide, phosphonic ester, and phosphinic ester, wherein the phosphine oxide, phosphonic ester, and phosphinic ester are phosphorus compounds represented by the following formulae (I), (II), and (III), respectively.

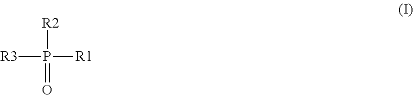

In the formula (I), R1 is an organic group having one or more unsaturated bonds, and the phosphorus and R1 are bonded to each other by a phosphorus-carbon (P—C) bond. R2 and R3 each independently represent a hydrocarbon group of 1 to 20 carbon atoms, or a hydrocarbon group of 1 to 20 carbon atoms whose halogen atoms are at least partially replaced with a halogen atom. R1, R2, and R3 are unbound to each other.

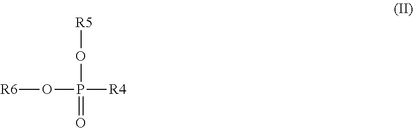

In the formula (II), R4 is an organic group having one or more unsaturated bonds, and the phosphorus and R4 are bonded to each other by a phosphorus-carbon (P—C) bond. R5 and R6 each independently represent a hydrocarbon group of 1 to 20 carbon atoms, or a hydrocarbon group of 1 to 20 carbon atoms whose halogen atoms are at least partially replaced with a halogen atom. R4, R5, and R6 are unbound to each other.

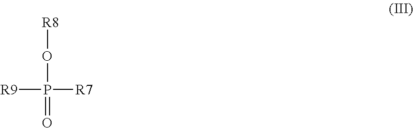

In the formula (III), R7 is an organic group having one or more unsaturated bonds, and the phosphorus and R7 are bonded to each other by a phosphorus-carbon (P—C) bond. R8 and R9 each independently represent a hydrocarbon group of 1 to 20 carbon atoms, or a hydrocarbon group of 1 to 20 carbon atoms whose halogen atoms are at least partially replaced with a halogen atom. R7, R8, and R9 are unbound to each other.

Still another embodiment of the present application is directed to a nonaqueous electrolytic secondary battery that includes: a positive electrode; a negative electrode; and an electrolyte that contains a nonaqueous electrolytic solution, the nonaqueous electrolytic solution containing at least one phosphorus compound selected from the group consisting of phosphine oxide, phosphonic ester, and phosphinic ester, wherein the phosphorus compound has a substituent that includes one or more unsaturated bonds, and the substituent has a carbon atom attached to the phosphorus.

Yet another embodiment of the present application is directed to a nonaqueous electrolytic solution that includes: at least one phosphorus compound selected from the group consisting of phosphine oxide, phosphonic ester, and phosphinic ester, wherein the phosphorus compound has a substituent that includes one or more unsaturated bonds, and the substituent has a carbon atom attached to the phosphorus.

Still yet another embodiment of the present application is directed to a battery pack, an electronic device, an electric vehicle, a power storage device, and a power system that include the nonaqueous electrolytic secondary battery of the embodiment of the present application.

In the embodiments of the present application, at least one phosphorus compound selected from the group consisting of phosphine oxide, phosphonic ester, and phosphinic ester is contained in the nonaqueous electrolytic solution. In this way, a side reaction of the electrodes and the electrolytic solution in a high-temperature environment can be suppressed. Deterioration of battery characteristics in a high-temperature environment can thus be suppressed.

As described above, the present application can provide excellent battery characteristics even in a high-temperature environment.

Additional features and advantages are described herein, and will be apparent from the following Detailed Description and the figures.

### BRIEF DESCRIPTION OF THE FIGURES

FIG. 1 is a cross sectional view illustrating an exemplary configuration of a nonaqueous electrolytic secondary battery according to First Embodiment of the present application.

FIG. 2 is a partially enlarged cross sectional view of a wound electrode unit illustrated in FIG. 1.

FIG. 3 is an exploded perspective view illustrating an exemplary configuration of a nonaqueous electrolytic secondary battery according to Second Embodiment of the present application.

FIG. 4 is a cross sectional view of a wound electrode unit of FIG. 3 along the line IV-IV.

FIG. 5 is a block diagram representing an exemplary configuration of a battery pack according to Third Embodiment of the present application.

FIG. 6 is a schematic diagram representing an example of the nonaqueous electrolytic secondary battery of the embodiment of the present application applied to a home power storage system.

FIG. 7 is a schematic diagram representing an exemplary configuration of a hybrid vehicle using a series hybrid system to which the present application is applied.

### DETAILED DESCRIPTION

The following will describe embodiments of the present application with reference to the accompanying drawings. Descriptions will be given in the following order.

(1) First Embodiment (Example of cylindrical battery)

(2) Second Embodiment (Example of flat battery)

(3) Third Embodiment (Example of battery pack using nonaqueous electrolytic secondary battery)

(4) Fourth Embodiment (Example of power storage system using nonaqueous electrolytic secondary battery)

### 1. First Embodiment

### Battery Configuration

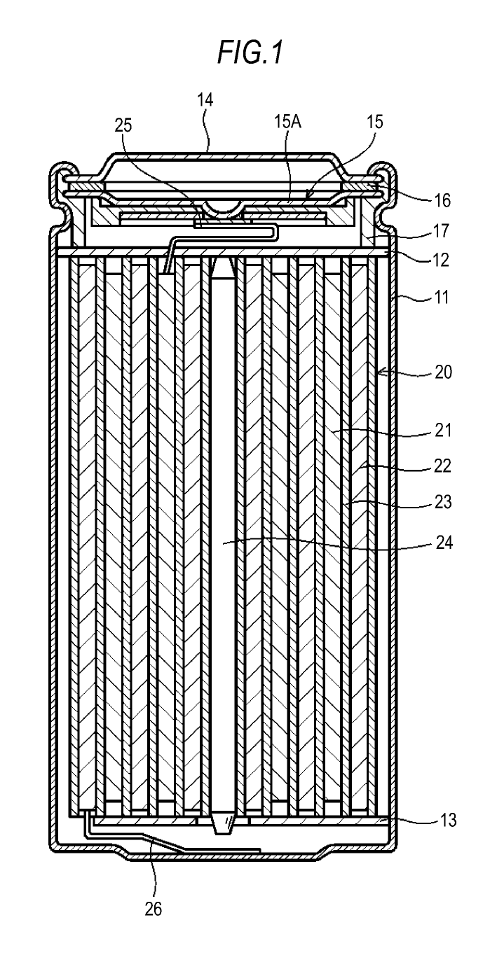

FIG. 1 is a cross sectional view illustrating an exemplary configuration of a nonaqueous electrolytic secondary battery according to First Embodiment of the present application. The nonaqueous electrolytic secondary battery is a lithium ion secondary battery in which the negative electrode capacity is represented by the capacitive component based on the storage and release of the electrode reaction substance lithium (Li). The nonaqueous electrolytic secondary battery is of a cylindrical type, and includes a substantially hollow cylindrical battery canister 11, and a wound electrode unit 20 including a pair of belt-like positive electrode 21 and negative electrode 22 wound around with a separator 23 laminated in between. The battery canister 11 is made of nickel (Ni)-plated iron (Fe), and has a closed end and an open end. The battery canister 11 includes an electrolytic solution injected therein, and the separator 23 is impregnated with the electrolytic solution. A pair of insulating plates 12 and 13 is disposed on the both sides of the wound electrode unit 20, perpendicularly to the rolled surface.

The battery canister 11 is sealed with a battery lid 14 fastened to the open end of the battery canister 11 by swaging via a sealing gasket 17, together with a safety valve mechanism 15 and a heat-sensitive resistive element (PTC: Positive Temperature Coefficient) 16 provided inside the battery lid 14. The battery lid 14 is formed using, for example, the same or similar materials used for the battery canister 11. The safety valve mechanism 15 is electrically connected to the battery lid 14, and cuts off the electrical connection between the battery lid 14 and the wound electrode unit 20 by the inversion of a disk plate 15A, when the pressure inside the battery reaches a certain level as a result of internal shorting or external heat. The sealing gasket 17 is formed using, for example, insulating material, and is asphalt-coated.

A center pin 24 is inserted at, for example, the center of the wound electrode unit 20. The positive electrode 21 of the wound electrode unit 20 is connected to a positive electrode lead 25 of, for example, aluminum (Al), and the negative electrode 22 is connected to a negative electrode lead 26 of, for example, nickel. The positive electrode lead 25 is electrically connected to the battery lid 14 by being welded to the safety valve mechanism 15. The negative electrode lead 26 is electrically connected to the battery canister 11 by being welded thereto.

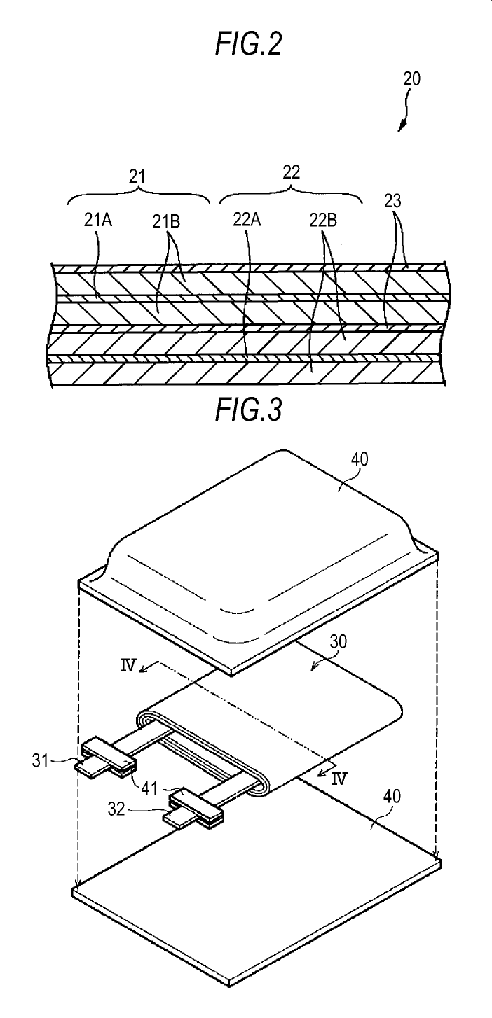

FIG. 2 is a partially magnified cross sectional view of the wound electrode unit 20 shown in FIG. 1. In the following, the positive electrode 21, the negative electrode 22, the separator 23, and the electrolytic solution forming the secondary battery are described in order, with reference to FIG. 2.

(Positive Electrode)

The positive electrode 21 is structured to include, for example, a positive electrode active material layer 21B provided on the both sides of a positive electrode collector 21A. The positive electrode active material layer 21B may be provided only on one side of the positive electrode collector 21A, though not illustrated. The positive electrode collector 21A is configured from metal foils, for example, such as an aluminum foil. The positive electrode active material layer 21B includes, for example, positive electrode active material, which is one or more positive electrode materials capable of storing and releasing lithium. Conductive agents such as graphite, and binders such as polyvinylidene fluoride are also contained, as required.

Lithium-containing compounds such as interlayer compounds containing, for example, lithium oxide, lithium phosphorus oxide, lithium sulfide, or lithium may be appropriately used as the positive electrode material capable of storing and releasing lithium, and these materials may be used as a mixture of two or more. Lithium-containing compounds containing lithium, a transition metal element, and oxygen (O) are preferably used to increase energy density. Examples of such lithium-containing compounds include a lithium composite oxide of formula (A) having a laminar rock salt-type structure, and a lithium composite phosphate of formula (B) having an olivine-type structure. The lithium-containing compound is preferably one containing at least one transition metal element selected from the group consisting of cobalt (Co), nickel (Ni), manganese (Mn), and iron (Fe). Examples of such lithium-containing compounds include a lithium composite oxide of formula (C), (D), or (E) having a laminar rock salt-type structure, a lithium composite oxide of formula (F) having a spinel-type structure, and a lithium composite phosphate of formula (G) having an olivine-type structure. Specific examples include LiNi_{0.50}Co_{0.20}Mn_{0.30}O₂, LiₐCoO₂ (a≈1), Li_{b}NiO₂ (b≈1), Li_{c1}Ni_{c2}CO_{1-c2}O₂ (c1≈1, 0<c2<1), Li_{d}Mn₂O₄ (d≈1), and LiₑFePO₄ (e≈1).

LiₚNi_{(1-q-r)}Mn_{q}M1ᵣO_{(2-y)}X_{z} (A)

(In the formula (A), M1 represents at least one selected from group 2 to 15 elements, excluding nickel (Ni) and manganese (Mn). X represents at least one selected from group 16 and 17 elements, excluding oxygen (O). p, q, y, and z are values that fall within the ranges 0≦p≦1.5, 0≦q≦1.0, 0≦r≦1.0, −0.10≦y≦0.20, and 0≦z≦0.2.)

LiₐM2_{b}PO₄ (B)

(In the formula (B), M2 represents at least one selected from group 2 to 15 elements. a and b are values that fall within the ranges 0≦a≦2.0, and 0.5≦b≦2.0.)

Li_{f}Mn_{(1-g-h)}Ni_{g}M3ₕO₍₂₋ⱼ₎Fₖ (C)

(In the formula (C), M3 represents at least one selected from the group consisting of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W). f, g, h, j, and k are values that fall within the ranges 0.8≦f≦1.2, 0<g<0.5, 0≦h≦0.5, g+h<1, −0.1≦j≦0.2, and 0≦k≦0.1. Note that the lithium composition varies depending on the charge and discharge state, and the f value represents a value in the fully discharged state.)

LiₘNi₍₁₋ₙ₎M4ₙO₍₂₋ₚ₎F_{q} (D)

(In the formula (D), M4 represents at least one selected from the group consisting of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W). m, n, p, and q are values that fall within the ranges 0.8≦m≦1.2, 0.005≦n≦0.5, −0.1≦p≦0.2, and 0≦q≦0.1. Note that the lithium composition varies depending on the charge and discharge state, and the m value represents a value in the fully discharged state.)

LiᵣCo₍₁₋ₛ₎M5ₛO₍₂₋ₜ₎F_{U} (E)

(In the formula (E), M5 represents at least one selected from the group consisting of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W). r, s, t, and u are values that fall within the ranges 0.8≦r≦1.2, 0≦s<0.5, −0.1≦t≦0.2, and 0≦u≦0.1. Note that the lithium composition varies depending on the charge and discharge state, and the r value represents a value in the fully discharged state.)

LiᵥMn_{2-w}M6_{w}OₓF_{y} (F)

(In the formula (F), M6 represents at least one selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W). v, w, x, and y are values that fall within the ranges 0.9≦v≦1.1, 0≦w≦0.6, 3.7≦x≦4.1, and 0≦y≦0.1. Note that the lithium composition varies depending on the charge and discharge state, and the v value represents a value in the fully discharged state.)

Li_{z}M7PO₄ (G)

(In the formula (G), M7 represents at least one selected from the group consisting of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), and zirconium (Zr). z is a value that falls within the range 0.9≦z≦1.1. Note that the lithium composition varies depending on the charge and discharge state, and the z value represents a value in the fully discharged state.)

Other examples of the positive electrode materials capable of storing and releasing lithium include inorganic compounds containing no lithium, such as MnO₂, V₂O₅, V₆O₁₃, NiS, and MoS.

The positive electrode materials capable of storing and releasing lithium may be different from those exemplified above. Further, the positive electrode materials exemplified above may be mixed in any combination of two or more.

(Negative Electrode)

The negative electrode 22 is structured to include, for example, a negative electrode active material layer 22B provided on the both sides of a negative electrode collector 22A. The negative electrode active material layer 22B may be provided only on one side of the negative electrode collector 22A, though not illustrated. The negative electrode collector 22A is configured from, for example, metal foils such as a copper foil.

The negative electrode active material layer 22B is configured to include a negative electrode active material, which may be one or more negative electrode materials capable of storing and releasing lithium. Other materials such as a binder also may be contained, as required, as in the positive electrode active material layer 21B.

In the secondary battery, the negative electrode material capable of storing and releasing lithium has a greater electrochemical equivalent than the positive electrode 21, in order to prevent deposition of the lithium metal on the negative electrode 22 during the charging process.

The negative electrode material that can store and release lithium may be carbon materials, for example, such as non-graphitizable carbon, easily graphitizable carbon, graphite, pyrolyzed carbons, cokes, glass-like carbons, organic polymer compound calcined products, carbon fibers, and activated carbon. Cokes include pitchcokes, needle cokes, and petroleum cokes. The organic polymer compound calcined products refer to carbonized products obtained by calcining polymer materials such as phenol resin and furan resin at appropriate temperatures, and some are classified as non-graphitizable carbon or easily graphitizable carbon. The polymer materials include polyacetylene and polypyrrole. These carbon materials are preferred because they undergo a very few changes in crystal structure during the charge and discharge, and thus provide high charge and discharge capacity and desirable cycle characteristics. Graphite is particularly preferred, because it has a large electrochemical equivalent, and can provide high energy density. Non-graphitizable carbons are preferred, because they can provide excellent characteristics. Further, materials having a low charge and discharge potential, specifically a charge and discharge potential close to that of lithium metal are preferred, because the battery energy density can easily improve. In the following, the negative electrode 22 using carbon material as the negative electrode material will be appropriately referred to as carbon negative electrode.

The negative electrode material that can store and release lithium may be, for example, material that is capable of storing and releasing lithium, and in which at least one of metallic elements and semi-metallic elements capable of forming an alloy with lithium is contained as the constituting element, because such materials also provide high energy density. It is particularly preferable to use such materials with carbon materials, because high energy density and excellent cycle characteristics can be provided. Such negative electrode materials may include a metallic element or a semi-metallic element either alone or as an alloy or a compound, or may at least partially include one or more phases of these. As used herein, the “alloy” encompasses an alloy of two or more metallic elements, and an alloy of one or more metallic elements and one or more semi-metallic elements. Further, the “alloy” may include a non-metallic element. The structure may be a solid solution, a eutectic (eutectic mixture), or an intermetallic compound, or a mixture of two or more of these. Further, the negative electrode material may be a complex in which a material containing at least one of metallic elements and semi-metallic elements as a constituting element is dispersed in an ion conductor. In this case, the complex may be dispersed with carbon material to produce the negative electrode active material layer 22B. In the following, the negative electrode 22 in which a material containing at least one of metallic elements and semi-metallic elements as a constituting element is used as the negative electrode material will be appropriately referred to as non-carbon negative electrode.

Examples of the metallic elements or semi-metallic elements forming the negative electrode material include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt). These may be crystalline or amorphous.

The negative electrode material is preferably material that includes a group 4B metallic element or semi-metallic element of the short form periodic table as a constituting element, particularly preferably material that includes at least one of silicon (Si) and tin (Sn) as a constituting element, because silicon (Si) and tin (Sn) excel in storing and releasing lithium (Li), and can thus provide high energy density.

Examples of tin (Sn) alloys include those containing at least one of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) as a non-tin (Sn) second constituting element. Examples of silicon (Si) alloys include those containing at least one of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) as a non-silicon (Si) second constituting element.

Examples of tin (Sn) compounds or silicon (Si) compounds include those containing oxygen (O) or carbon (C), and the second constituting elements above may be contained in addition to tin (Sn) or silicon (Si).

Particularly preferred as the negative electrode material is a SnCoC-containing material that contains cobalt (Co), tin (Sn), and carbon (C) as constituting elements, and in which the carbon content ranges from 9.9 mass % to 29.7 mass %, and in which the proportion of the cobalt (Co) with respect to the total of tin (Sn) and cobalt (Co) ranges from 30 mass % to 70 mass %. High energy density and excellent cycle characteristics can be obtained in these composition ranges.

The SnCoC-containing material may contain other constituting elements, as required. Examples of other constituting elements include silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga), and bismuth (Bi), which may be contained in a combination of two or more. In this way, capacity or cycle characteristics can be further improved.

It is preferable that the SnCoC-containing material include a tin (Sn)-, cobalt (Co)-, and carbon (C)-containing phase, and that this phase has a low-crystalline or amorphous structure. Further, it is preferable in the SnCoC-containing material that at least some of the constituting element carbon (C) atoms bind to the other constituting elements, namely, the metallic element or semi-metallic element. It is believed that deterioration of cycle characteristics occurs as a result of agglomeration or crystallization of tin (Sn) or other elements. Binding of carbon (C) with other elements can suppress such agglomeration or crystallization.

Other examples of the negative electrode material that can store and release lithium include other metal compounds and polymer materials. Examples of such metal compounds include oxides such as MnO₂, V₂O₅, and V₆O₁₃, sulfides such as NiS, and MoS, and lithium nitrides such as LiN₃. Examples of the polymer materials include polyacetylene, polyaniline, and polypyrrole.

The negative electrode active material layer 22B of the non-carbon negative electrode may be, for example, a coating-type or a thin-film negative electrode active material layer 22B.

The thickness of the thin-film negative electrode active material layer 22B ranges from, for example, 70 to 80 μm. The thin-film negative electrode active material layer 22B is formed of, for example, a negative electrode active material. The negative electrode active material is a negative electrode material that contains at least one of the metallic elements and semi-metallic elements above as a constituting element.

The thickness of the coating-type negative electrode active material layer 22B ranges from, for example, 5 to 6 μm. The coating-type negative electrode active material 22B is formed of, for example, a negative electrode active material, and, as required, a conductive agent and a binder. The negative electrode active material is a negative electrode material that contains at least one of the metallic elements and the semi-metallic elements above as a constituting element.

When the non-carbon negative electrode is used as the negative electrode 22, it is preferable that a part of or all of the materials contained as constituting elements in the negative electrode active material layer 22B form an alloy with the negative electrode collector 22A forming the negative electrode 22. In this way, the adhesion between the negative electrode active material layer 22B and the negative electrode collector 22A can be improved. Specifically, it is preferable that the constituting elements of the negative electrode collector 22A diffuse into the negative electrode active material layer 22B at the interface, or the constituting elements of the negative electrode active material layer 22B diffuse into the negative electrode collector 22A at the interface. It is also preferable that the constituting elements of these layers diffuse into the other layer at the interface. In this way, falling from the negative electrode collector 22A can be suppressed even when the negative electrode active material layer 22B expands or contracts during the charge and discharge. Note that the element diffusion is also regarded as the alloying as used in the embodiment of the present application.

When the non-carbon negative electrode is used as the negative electrode 22, it is preferable that the powders of the metallic element and the semi-metallic element capable of forming an alloy with lithium have a primary particle diameter of from 0.1 μm to 35 μm, preferably 0.1 μm to 25 μm. Particle diameters below these ranges are not preferable, because it facilitates the undesirable reaction between the particle surfaces and the electrolytic solution (described later), and may lower capacity or efficiency. Particle diameters above these ranges are not preferable, because it makes the reaction with the lithium difficult inside the particles, and may lower capacity. The particle diameter may be measured by observation using a light microscope or an electron microscope, or by using a laser diffraction method. Preferably, these methods are used as may be appropriate for the particle diameter range. It is also preferable to perform classification to obtain a desired particle diameter. The classification method is not particularly limited, and may be performed by a dry method or a wet method with a sieve or a wind classification device.

The powders of the metallic element and the semi-metallic element capable of forming an alloy with lithium may be produced by using methods commonly used, for example, for powder metallurgy. Examples of such methods include methods involving pulverization after the melting and cooling of raw material in a melting furnace such as an arc furnace and a high-frequency induction heat furnace; methods involving rapid cooling of the molten metal from the raw material, such as single-roll rapid cooling, twin-roll rapid cooling, gas atomization, water atomization, and centrifugal atomization; and methods involving pulverization by methods such as mechanical alloying after solidifying the molten metal from the raw material by using methods such as single-roll rapid cooling, and twin-roll rapid cooling. Gas atomization and mechanical alloying are particularly preferred. Note that the synthesis and pulverization are performed preferably in an inert gas atmosphere such as in argon, nitrogen, and helium, or in a vacuum atmosphere, in order to prevent oxidation due to the oxygen in air.

Further, when the non-carbon negative electrode is used as the negative electrode 22, oxygen should be contained as a constituting element of the negative electrode active material layer 22B, because oxygen suppresses the expansion and contraction of the negative electrode active material layer 22B, and can thus suppress deterioration of discharge capacity, and swelling. Preferably, the oxygen contained in the negative electrode active material layer 22B at least partially binds to at least one of the metallic elements and the semi-metallic elements capable of forming an alloy with lithium. The state of binding may be a monoxide or dioxide state, or may be a metastable state.

The content of the oxygen in the negative electrode active material layer 22B is preferably from 3 atomic percent to 45 atomic percent. A sufficient oxygen containing effect cannot be obtained with an oxygen content less than 3 atomic percent. An oxygen content above 45 atomic percent lowers the energy capacity of the battery, and increases the resistance value of the negative electrode active material layer 22B. The resulting local lithium insertion is believed to cause swelling, and lower cycle characteristics. Note that the coating formed on the surface of the negative electrode active material layer 22B as a result of decomposition of the electrolytic solution or other components after the charge and discharge is not included in the negative electrode active material layer 22B. Thus, the oxygen content in the negative electrode active material layer 22B is the value calculated without the coating.

When the non-carbon negative electrode is used as the negative electrode 22, it is preferable that the negative electrode active material layer 22B be formed by at least one method selected from the group consisting of a vapor-phase method, a liquid-phase method, and a sinter method. In this way, destruction due to the expansion and contraction of the negative electrode active material layer 22B after the charge and discharge can be suppressed more reliably, and the negative electrode collector 22A and the negative electrode active material layer 22B can have greater integrity. This improves the electron conductivity in the negative electrode active material layer 22B. It is also possible to reduce or exclude the binder and voids, making it possible to reduce the thickness of the negative electrode 22. As used herein, “calcining method” refers to a method in which a layer formed by mixing and molding an active material-containing powder and a binder is subjected to heat treatment under, for example, a non-oxidative atmosphere to form a dense layer having a higher volume density than the layer before the heat treatment.

(Separator)

The separator 23 is provided to isolate the positive electrode 21 and the negative electrode 22 from each other, and allows for passage of lithium ions while preventing current shorting caused by contacting of the electrodes. The separator 23 may be, for example, a porous film of synthetic resin such as polytetrafluoroethylene, polypropylene, and polyethylene, a ceramic porous film, or a laminate of two or more of such porous films. Particularly preferred as the separator 23 is a polyolefin porous film, because it has an excellent shorting preventing effect, and can improve battery safety by the shutdown effect. Further, the separator 23 may be one in which a porous resin layer such as polyvinylidene fluoride (PVdF), and polytetrafluoroethylene (PTFE) is formed on a microporous film such as polyolefin.

(Electrolytic Solution)

The electrolytic solution is a liquid electrolyte, and contains a solvent, an electrolyte salt, and a phosphorus compound added as an additive. The electrolyte salt and the phosphorus compound are dissolved in the solvent. The electrolytic solution may contain additives other than the phosphorus compound, as required.

(Solvent)

The solvent may be a nonaqueous solvent, including, for example, ethylene carbonate (EC), propylene carbonate, butylene carbonate, dimethyl carbonate (DMC), diethyl carbonate, ethyl methyl carbonate, methyl propyl carbonate, γ-butyrolactone, γ-valerolactone, 1,2-dimethoxyethane, tetrahydrofuran, 2-methyltetrahydrofuran, tetrahydropyran, 1,3-dioxolan, 4-methyl-1,3-dioxolan, 1,3-dioxane, 1,4-dioxane, methyl acetate, ethyl acetate, methyl propionate, ethyl propionate, methyl butyrate, isomethyl butyrate, trimethylmethyl acetate, trimethylethyl acetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethyl-imidazolidinone, nitromethane, nitroethane, sulfolane, trimethyl phosphate, and dimethyl sulfoxide.

The solvents exemplified above may be used either alone or appropriately in a combination of two or more. Of these solvents, at least one selected from ethylene carbonate, propylene carbonate, dimethyl carbonate, diethyl carbonate, and ethyl methyl carbonate is preferred. In this case, it is preferable to use a high-viscosity (high-dielectric) solvent (for example, relative permittivity ∈≧30), for example, such as ethylene carbonate and propylene carbonate, as a mixture with a low-viscosity solvent (for example, viscosity ≦1 mPa·s), for example, such as dimethyl carbonate, ethyl methyl carbonate, and diethyl carbonate. The use of such mixtures improves the dissociation of the electrolyte salt and ion mobility.

(Unsaturated or Halogenated Carbonate Esters)

The electrolytic solution preferably contains the additive phosphorus compound, and at least one of halogenated carbonate esters and unsaturated carbonate esters.

(Halogenated Carbonate Esters)

Halogenated carbonate esters are carbonate esters containing a halogen. With the halogenated carbonate ester contained in the electrolytic solution, a stable protective film is formed on the electrode surfaces during the electrode reaction, and the degradation reaction of the electrolytic solution is suppressed. Examples of the halogenated carbonate esters include halogenated chain carbonate esters represented by general formula (I), and halogenated cyclic carbonate esters represented by general formula (II).

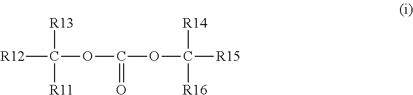

In the formula (I), R11 to R16 are each independently a hydrogen atom, a halogen atom, an alkyl group, or a halogenated alkyl group. At least one of R11 to R16 is a halogen atom or a halogenated alkyl group.

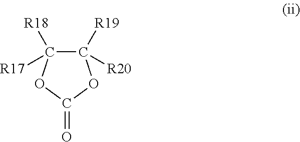

In the formula (II), R17 to R20 are each independently a hydrogen atom, a halogen atom, an alkyl group, or a halogenated alkyl group. At least one of R17 to R20 is a halogen atom or a halogenated alkyl group.

Specific examples of the halogenated chain carbonate esters of general formula (I) include fluoromethyl carbonate (FDMC), and bis(fluoromethyl)carbonate (DFDMC).

Specific examples of the halogenated cyclic carbonate esters of general formula (II) include 4-fluoro-1,3-dioxolan-2-one (FEC), and 4,5-difluoro-1,3-dioxolan-2-one (DFEC).

(Unsaturated Carbonate Esters)

Unsaturated carbonate esters are carbonate esters containing an unsaturated bond. With the unsaturated carbonate ester contained in the electrolytic solution, a stable protective film is formed on the electrode surfaces during the electrode reaction, and the degradation reaction of the electrolytic solution is suppressed. Examples of the unsaturated carbonate esters include unsaturated cyclic carbonate esters represented by general formulae (iii) to (v).

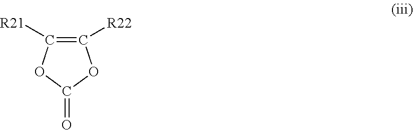

In the formula (iii), R21 and R22 are each independently a hydrogen atom, a halogen atom, an alkyl group, or a halogenated alkyl group.

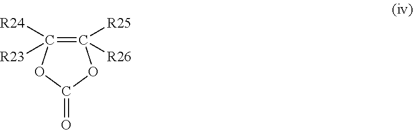

In the formula (iv), R23 to R26 are each independently a hydrogen atom, an alkyl group, a vinyl group, or an allyl group. At least one of R23 to R26 is a vinyl group or an allyl group.

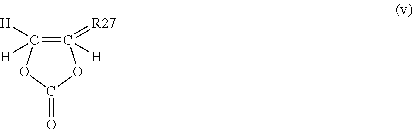

In the formula (v), R27 is an alkylene group.

The unsaturated cyclic carbonate esters of general formula (iii) are vinylene carbonate compounds. Examples of the vinylene carbonate compounds include vinylene carbonate, methylvinylene carbonate, and ethylvinylene carbonate. Other examples include 4,5-dimethyl-1,3-dioxol-2-one, 4,5-diethyl-1,3-dioxol-2-one, 4-fluoro-1,3-dioxol-2-one, and 4-trifluoromethyl-1,3-dioxol-2-one. Vinylene carbonate is preferred, because it is readily available, and can provide high effects.

The unsaturated cyclic carbonate esters of general formula (Iv) are vinyl ethylene carbonate compounds. Examples of the vinyl ethylene carbonate compounds include vinyl ethylene carbonate, 4-methyl-4-vinyl-1,3-dioxolan-2-one, and 4-ethyl-4-vinyl-1,3-dioxolan-2-one. Other examples include 4-n-propyl-4-vinyl-1,3-dioxolan-2-one, 5-methyl-4-vinyl-1,3-dioxolan-2-one, 4,4-divinyl-1,3-dioxolan-2-one, and 4,5-divinyl-1,3-dioxolan-2-one. Vinyl ethylene carbonate is preferred, because it is readily available, and can provide high effects. All of R23 to R26 may be vinyl groups or allyl groups, or vinyl groups and allyl groups may coexist.

The unsaturated cyclic carbonate esters of general formula (v) are methylene ethylene carbonate compounds. Examples of the methylene ethylene carbonate compounds include 4-methylene-1,3-dioxolan-2-one, 4,4-dimethyl-5-methylene-1,3-dioxolan-2-one, and 4,4-diethyl-5-methylene-1,3-dioxolan-2-one. The methylene ethylene carbonate compounds may contain a single methylene group (compounds of general formula (v)), or two methylene groups.

The unsaturated carbonate ester may be, for example, catechol carbonate having a benzene ring.

(Electrolyte Salt)

Examples of the electrolyte salt include lithium salts, which may be used either alone or as a mixture of two or more. Examples of lithium salts include LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, lithium difluoro[oxolato-O,O′]borate, lithium bis(oxalate)borate, and LiBr. LiPF₆ is preferred, because it can provide high ion conductivity, and can improve cycle characteristics.

(Phosphorus Compound)

The additive phosphorus compound may be at least one organophosphate compound selected from the group consisting of phosphine oxide, phosphonic ester (phosphonate), and phosphinic ester (phosphinate). The organophosphate compound includes a substituent having one or more unsaturated bonds, and the substituent has a carbon atom attached to the phosphorus. The unsaturated bonds are preferably carbon-carbon unsaturated bonds. The phosphine oxide, phosphonic ester, and phosphinic ester are preferably non-cyclic phosphine oxide, non-cyclic phosphonic ester, and non-cyclic phosphinic ester, respectively, in which there is no binding between the substituents that directly bind to the phosphorus.

In the embodiment of the present application, it is important that the unsaturated bond (multiple bond)-containing organic group and the phosphorus be bonded to each other by a phosphorus-carbon bond. Though details are not known, it is believed that this ensures the binding between the unsaturated bond-containing organic group and the phosphorus, and contributes to the co-decomposition of the two.

With the phosphorus compound contained in the electrolytic solution, a coating originating in the phosphorus compound is formed on the surface of at least one of the positive and negative electrodes during the electrode reaction, specifically, at the time of initial charging or subsequent charging. The coating can improve battery characteristics such as high-temperature storage characteristics, and high-temperature cycle characteristics. The coating originating in the phosphorus compound is a SEI (Solid Electrolyte Interface).

The content of the phosphorus compound (the total amount of the phosphine oxide, phosphonic ester, and phosphinic ester compound) with respect to the electrolytic solution is preferably from 0.01 mass % to 5 mass %, more preferably 0.01 mass % to 1 mass %, further preferably 0.1 mass % to 1 mass %. With the content less than 0.01 mass %, high-temperature storage characteristics and high-temperature cycle characteristics tend to deteriorate. With the content above 5 mass %, high-temperature storage characteristics and high-temperature cycle characteristics also tend to deteriorate.

More specifically, the phosphorus compounds phosphine oxide, phosphonic ester, and phosphinic ester are preferably organophosphate compounds represented by the general formulae (I) to (III) below, respectively. The presence or absence of the phosphorus compounds of general formulae (I) to (III) in the electrolytic solution can be confirmed by using techniques such as gas chromatography, liquid chromatography, and mass spectrography. The phosphorus compound content can be measured with a standard curve by using the foregoing analysis techniques.

(Phosphine Oxide)

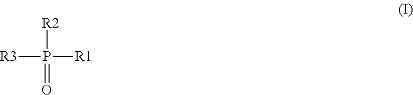

In the formula (I), R1 is an organic group having one or more unsaturated bonds, and the phosphorus and R1 are bonded to each other by a phosphorus-carbon (P—C) bond. R2 and R3 each independently represent a hydrocarbon group of 1 to 20 carbon atoms, or a hydrocarbon group of 1 to 20 carbon atoms whose halogen atoms are at least partially replaced with a halogen atom. R2 and R3 may be the same organic group. R1, R2, and R3 are unbound to each other.

(Phosphonic Ester)

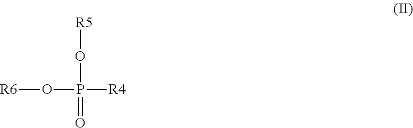

In the formula (II), R4 is an organic group having one or more unsaturated bonds, and the phosphorus and R4 are bonded to each other by a phosphorus-carbon (P—C) bond. R5 and R6 each independently represent a hydrocarbon group of 1 to 20 carbon atoms, or a hydrocarbon group of 1 to 20 carbon atoms whose halogen atoms are at least partially replaced with a halogen atom. R5 and R6 may be the same organic group. R4, R5, and R6 are unbound to each other.

(Phosphinic Ester)

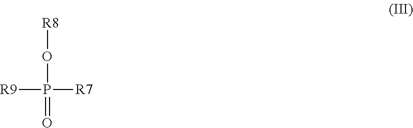

In the formula (III), R7 is an organic group having one or more unsaturated bonds, and the phosphorus and R7 are bonded to each other by a phosphorus-carbon (P—C) bond. R8 and R9 each independently represent a hydrocarbon group of 1 to 20 carbon atoms, or a hydrocarbon group of 1 to 20 carbon atoms whose halogen atoms are at least partially replaced with a halogen atom. R8 and R9 may be the same organic group. R7, R8, and R9 are unbound to each other.

(R1, R4, R7)

The following describes the R1, R4, R7 in the general formulae (I) to (III). The unsaturated bond in the organic groups R1, R4, and R7 is preferably a carbon-carbon unsaturated bond. The carbon-carbon unsaturated bond is preferably a double bond or a triple bond, and the double bond and the triple bond may be contained in a single substituent. The position of the unsaturated bond in the substituent is not limited, and the carbon forming the unsaturated bond may be directly bonded to the phosphorus, or may be at the substituent terminal

The organic groups R1, R4, and R7 contain preferably 2 to 20 carbon atoms. With the number of carbon atoms less than two, the SEI intended in the embodiment of the present application cannot be obtained because of the lack of the carbon-carbon unsaturated bond. On the other hand, with the number of carbon atoms exceeding twenty, the proportion of the phosphorus in the SEI formed on the electrode surface becomes small, and the SEI cannot be obtained as desired in the embodiment of the present application. The result is a tendency to lower high-temperature storage characteristics and high-temperature cycle characteristics.

The organic groups R1, R4, and R7 are preferably unsaturated hydrocarbon groups having one or more carbon-carbon double bonds or triple bonds, or unsaturated hydrocarbon groups having one or more carbon-carbon double bonds or triple bonds partially replaced with a substituent. Preferably, a phenyl group is excluded from R1, R4, and R7.

The unsaturated hydrocarbon group may be, for example, an unsaturated hydrocarbon group having a chain and/or cyclic structures. The chain structure may be linear or branched. The unsaturated hydrocarbon group is, for example, an unsaturated hydrocarbon group having a conjugated structure and/or a nonconjugated structure. Specific examples of the unsaturated hydrocarbon group include an alkenyl group, an alkadienyl group, an alkatrienyl group, an alkatetraenyl group, an alkynyl group, an alkydienyl group, an alkylrienyl group, an alkatetraenyl group, a cycloalkenyl group, a cycloalkadienyl group, a cycloalkatrienyl group, a cycloalkatetraenyl group, a cycloalkynyl group, a cycloalkydienyl group, a cycloalkylrienyl group, and a cycloalkatetraenyl group. Preferred examples include, but are not limited to, an alkenyl group, an alkadienyl group, an alkynyl group, and an alkydienyl group.

The substituent may be, for example, at least one selected from the group consisting of a halogen atom, an oxy group, an epoxy group, a carbonyl group, an ester group, a nitrile group, a carbonate group, a sulfide group, a sulfinyl group, a sulfonyl group, a sulfonyloxy group, an alkyl group, an alkenyl group, an alkynyl group, a phenyl group, a phenylene group, an aralkyl group, and these groups whose hydrogen atoms are at least partially replaced with a halogen group. Specific examples of the substituents whose hydrogen atoms can be at least partially replaced with a halogen atom include hydrogen-containing substituents such as an alkyl group, an alkenyl group, an alkynyl group, a phenyl group, a phenylene group, and an aralkyl group. The halogen atom may be, for example, at least one selected from the group consisting of a fluorine atom, a chlorine atom, a bromine atom, and an iodine atom.

Examples of the unsaturated hydrocarbon group partially replaced with a substituent include groups in which at least one of the hydrogen and the methylene group contained in the unsaturated hydrocarbon group is replaced with a substituent. For example, the substituent for the hydrogen may be, but is not limited to, at least one selected from the group consisting of a halogen atom, an oxy group, an epoxy group, a nitrile group, an alkyl group, an alkenyl group, an alkynyl group, and a phenyl group. For example, the substituent for the methylene group may be, but is not limited to, at least one selected from the group consisting of a carbonyl group, an ester group, a carbonate group, a sulfide group, a sulfinyl group, a sulfonyl group, a sulfonyloxy group, and a phenylene group.

Specific examples of R1, R4, and R7 in the general formulae (I) to (III) include the substituents represented by the structural formulae (I) to (26) below. X₁ and X₂ are substituents represented by —R or —OR. More specifically, X₁ is —R2, —O—R5, or —O—R8, and X₂ is R3, —O—R6, or R9.

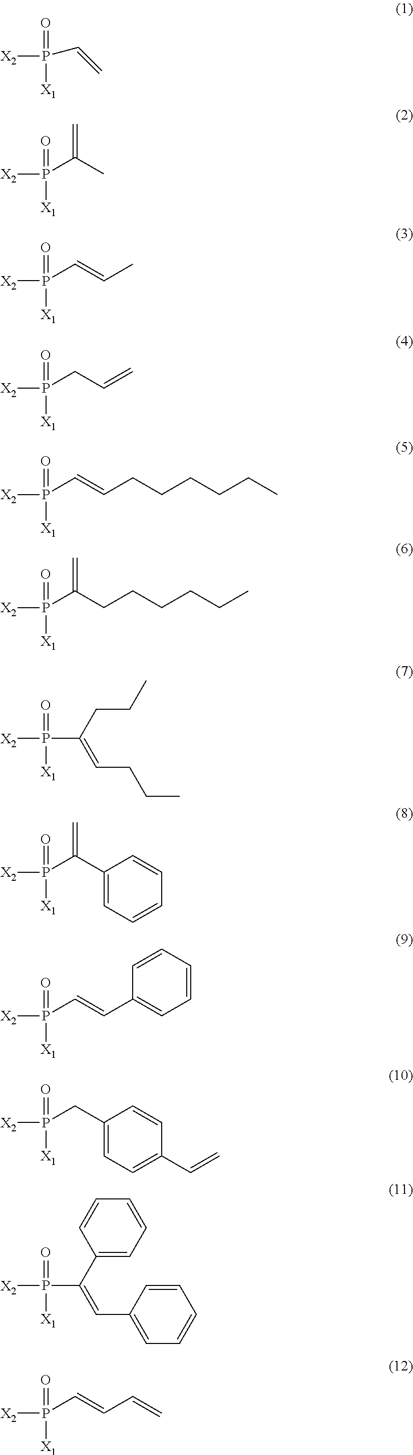

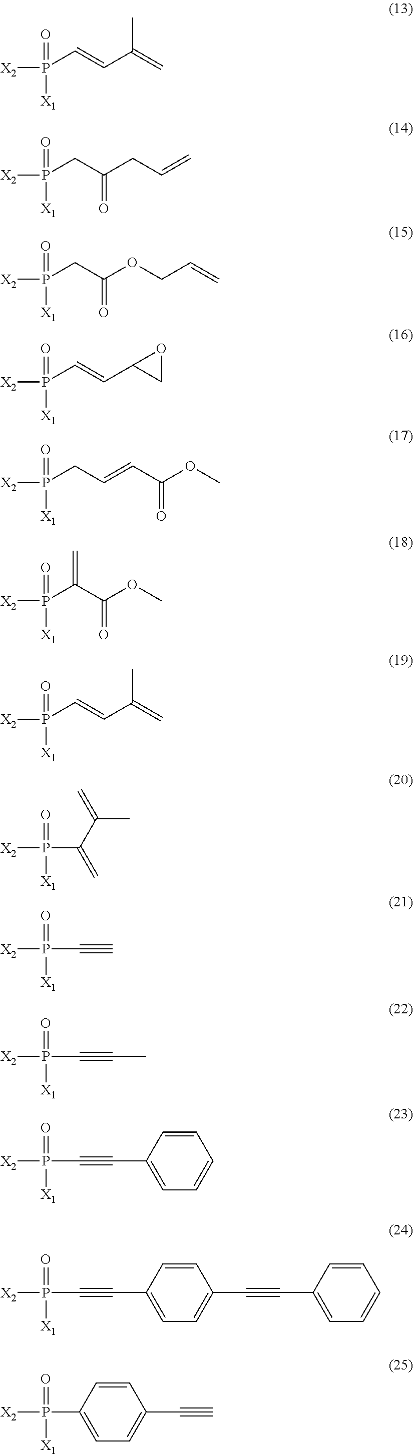

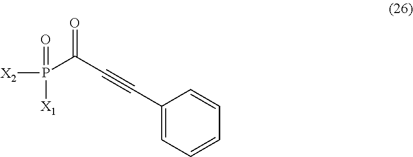

Note that the structural formulae (1) to (26) represent specific examples of the substituents R1, R4, and R7, as follows.

Structural formulae (1) to (7): Specific examples of an alkenyl group

Structural formulae (8) and (9): Specific examples of a group which is an alkenyl group whose hydrogen atoms are partially replaced with a phenyl group

Structural formula (10): Specific example of a group which is an alkenyl group whose methylene groups are partially replaced with a phenylene group

Structural formula (11): Specific example of a group which is an alkenyl group whose hydrogen atoms are partially replaced with a phenyl group

Structural formulae (12) and (13): Specific examples of an alkadienyl group

Structural formula (14): Specific example of a group which is an alkenyl group whose methylene groups are partially replaced with a carbonyl group

Structural formula (15): Specific example of a group which is an alkenyl group whose methylene groups are partially replaced with an ester group

Structural formula (16): Specific example of a group which is an alkenyl group whose hydrogen atoms are partially replaced with an epoxy group

Structural formulae (17) and (18): Specific examples of a group which is an alkenyl group whose methylene groups are partially replaced with an ester group

Structural formulae (19) and (20): Specific examples of an alkadienyl group

Structural formulae (21) and (22): Specific examples of an alkynyl group

Structural formula (23): Specific example of a group which is an alkynyl group whose hydrogen atoms are partially replaced with a phenyl group

Structural formula (24): Specific example of a group which is an alkadienyl group whose methylene groups are partially replaced with a phenylene group, and whose hydrogen atoms are partially replaced with a phenyl group

Structural formula (25): Specific example of a group which is an alkynyl group whose methylene groups are partially replaced with a phenylene group

Structural formula (26): Specific example of a group which is an alkynyl group whose methylene groups are partially replaced with a carbonyl group, and whose hydrogen atoms are partially replaced with a phenyl group

(R2 and R3, R5 and R6, and R7 and R8)

The following describes the R2 and R3, R5 and R6, and R7 and R8 in the general formulae (I) to (III). R2 and R3, R5 and R6, and R7 and R8 have, for example, 1 to 30, preferably 1 to 20 carbon atoms in the hydrocarbon group.

Examples of the hydrocarbon group include an alkyl group, a cycloalkyl group, an alkenyl group, an aryl group, and an aralkyl group. The aryl group may be of a monocyclic or a polycyclic system. Non-limiting examples of the aryl group of a monocyclic system include a phenyl group, and non-limiting examples of the aryl group of a polycyclic system include a naphthyl group. The halogen atom may be, for example, at least one selected from the group consisting of a fluorine atom, chlorine atom, a bromine atom, and an iodine atom.

Specific examples of R2 and R3, R5 and R6, and R7 and R8 include the substituents represented by the following structural formulae (27) to (40).

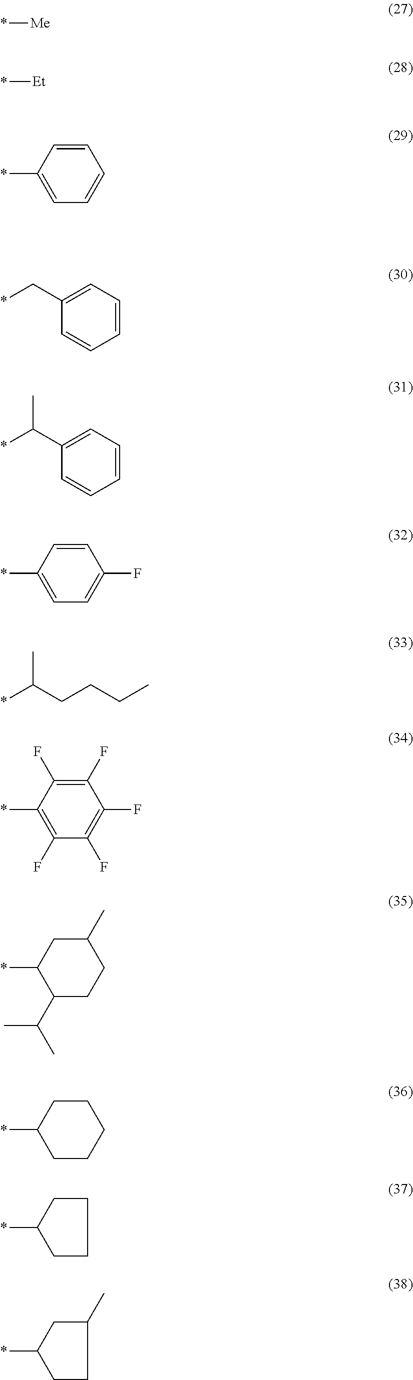

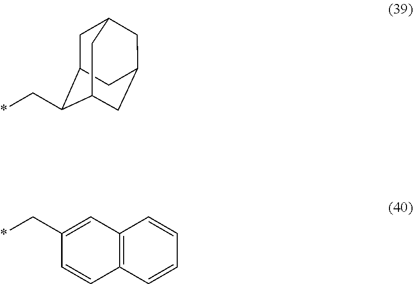 [SMILES: *CC1C2CC3CC(C2)CC1C3 ; *Cc1ccc2ccccc2c1]

Note that the structural formulae (27) to (40) represent specific examples of the substituents R2 and R3, R5 and R6, and R7 and R8.

Structural formulae (27) and (28): Specific examples of an alkyl group

Structural formula (29): Specific example of an aryl group

Structural formulae (30) and (31): Specific examples of an aralkyl group

Structural formula (32): Specific example of a group which is an alyl group whose hydrogen atoms are partially replaced with a halogen atom

Structural formula (33): Specific example of an alkyl group

Structural formula (34): Specific example of a group which is an alyl group whose hydrogen atoms are all replaced with a halogen atom

Structural formula (35): Specific example of a group which is a cycloalkyl group whose hydrogen atoms are partially replaced with an alkyl group

Structural formulae (36) and (37): Specific examples of a cycloalkyl group

Structural formula (38): Specific example of a group which is a cycloalkyl group whose hydrogen atoms are partially replaced with an alkyl group

Structural formula (39): Specific example of an adamantyl group

Structural formula (40): Specific example of an aralkyl group

Note that use of the phosphorus compound is not restricted by the composition of the electrolytic solution, or by the type of the positive and negative electrodes. Further, additives other than the phosphorus compound added to the electrolytic solution do not generally inhibit the effects exhibited by the addition of the phosphorus compound, and the effects of additives other than the phosphorus compound are not generally inhibited by the addition of the phosphorus compound.

[Battery Producing Method]

The following describes an example of a method for producing the nonaqueous electrolytic secondary battery according to First Embodiment of the present application.

First, for example, a positive electrode active material, a conductive agent, and a binder are mixed to prepare a positive electrode mixture, and the positive electrode mixture is dispersed in a solvent such as N-methyl-2-pyrrolidone to produce a paste-like positive electrode mixture slurry. The positive electrode mixture slurry is then applied to the positive electrode collector 21A, and, after drying the solvent, the positive electrode active material layer 21B is formed by compression molding using a roller press machine or the like. As a result, the positive electrode 21 is formed.

When the negative electrode 22 is a carbon negative electrode, for example, a negative electrode active material (carbon material) and a binder are mixed to prepare a negative electrode mixture, and the negative electrode mixture is dispersed in a solvent such as N-methyl-2-pyrrolidone to produce a paste-like negative electrode mixture slurry. The negative electrode mixture slurry is then applied to the negative electrode collector 22A, and, after drying the solvent, the negative electrode active material layer 22B is formed by compression molding using a roller press machine or the like. As a result, the negative electrode 22 is produced.

When the negative electrode 22 is a non-carbon negative electrode, the producing method of the negative electrode 22 varies depending on whether the negative electrode active material layer 22B is a coating-type or a thin-film. In the following, non-carbon negative electrode producing methods for coating-type and thin-film negative electrode active material layers 22B are described.

For the formation of the coating-type negative electrode active material layer 22B, for example, a material (negative electrode active material) that can store and release lithium, and that contains at least one of metallic elements and semi-metallic elements as a constituting element is pulverized into fine particles. As required, the fine particles are mixed with a conductive agent and a binder to prepare a mixture. The mixture is then dispersed in a dispersion medium such as N-methylpyrrolidone (NMP) to obtain a slurry. The mixture slurry is applied to the negative electrode collector 22A, and the dispersion medium is evaporated. This is followed by compression molding to produce the negative electrode 22.

For example, the coating method may be, but is not particularly limited to, a microgravure coating method, a wire bar coating method, a direct gravure coating method, a die coating method, a dipping method, a spray coating method, a reverse roller coating method, a curtain coating method, a comma coating method, a knife coating method, or a spin coating method.

For the formation of the thin-film negative electrode active material layer 22B, the negative electrode active material layer 22B capable of storing and releasing lithium and containing at least one of metallic elements and semi-metallic elements as a constituting element is deposited on the negative electrode collector 22A by using, for example, a vapor-phase method, a spray method, a calcining method, or a liquid-phase method. The vapor-phase method may be, for example, a physical deposition method or a chemical deposition method. Specific examples include a vacuum vapor deposition method, a sputtering method, an ion plating method, a laser abrasion method, a CVD method (Chemical Vapor Deposition method), and a spray method. The liquid-phase method may be, for example, plating. These methods may be used in a combination of two or more, or may be combined with other methods to deposit the negative electrode active material layer 22B.

When containing oxygen in the negative electrode active material layer 22B, the oxygen content is adjusted, for example, by containing oxygen in the atmosphere used to form the negative electrode active material layer 22B, or in the atmosphere used for calcining or heat treatment, or by adjusting the oxygen concentration in the negative electrode active material particles used.

After forming the negative electrode active material layer 22B, a heat treatment may be performed in a vacuum atmosphere or in a non-oxidative atmosphere to further facilitate alloying at the interface of the negative electrode collector 22A and the negative electrode active material layer 22B.

Thereafter, the positive electrode lead 25 is attached to the positive electrode collector 21A, and the negative electrode lead 26 to the negative electrode collector 22A by using a method such as welding. The positive electrode 21 and the negative electrode 22 are then wound around with the separator 23 laminated in between. Thereafter, the positive electrode lead 25 and the negative electrode lead 26 are welded to the safety valve mechanism 15 and the battery canister 11, respectively, at the leading ends. The wound positive electrode 21 and negative electrode 22 are housed inside the battery canister 11 by being placed between the insulating plates 12 and 13. With the positive electrode 21 and the negative electrode 22 housed inside the battery canister 11, an electrolytic solution containing a phosphorus compound is injected into the battery canister 11 to impregnate the separator 23. The battery lid 14, the safety valve mechanism 15, and the heat-sensitive resistive element 16 are then swaged to the open end of the battery canister 11 via the sealing gasket 17. This completes the secondary battery illustrated in FIG. 1.

In the nonaqueous electrolytic secondary battery of First Embodiment, for example, the electrolyte electrolytic solution contains at least one organophosphate compound selected from the group consisting of a phosphine oxide of formula (I), a phosphonic ester of formula (II), and a phosphinic ester of formula (III). This makes it possible to suppress the side reaction between the electrode active material and the electrolytic solution during the storage in a high-temperature environment (high-temperature storage characteristics) and during use (high-temperature cycle characteristics). It is therefore possible to suppress capacity deterioration in a high-temperature environment, and to improve high-temperature storage characteristics and high-temperature cycle characteristics.

The effect of adding the phosphorus compound is believed to be the result of the following. By the preferential decomposition of the groups with unsaturated bonds contained in the molecules of formulae (I) to (III), an SEI (Solid Electrolyte Interface; solid electrolyte film) containing large numbers of phosphorus elements effective at improving high-temperature storage characteristics and high-temperature cycle characteristics densely occurs on the electrode surfaces (for example, on the surface of at least one of the positive and negative electrodes). This suppresses the side reaction during the storage and use of the secondary battery in a high-temperature environment.

The phosphine oxide, phosphonic ester, and phosphinic ester used as the organophosphate compounds do not have hydrogen directly attached to the phosphorus, and protonic hydrogen atoms are absent in the substituent binding to the phosphorus. It is believed that this suppresses the inadvertent side reactions, and improves the high-temperature characteristics of the secondary battery.

### 2. Second Embodiment

### Battery Configuration

FIG. 3 is an exploded perspective view illustrating an exemplary configuration of a nonaqueous electrolytic secondary battery according to Second

Embodiment of the present application. The secondary battery is structured to include a film-like exterior member 40, and a wound electrode unit 30 housed in the exterior member 40 with a positive electrode lead 31 and a negative electrode lead 32 attached to the wound electrode unit 30. The battery is therefore small, light, and thin.

For example, the positive electrode lead 31 and the negative electrode lead 32 lead out in the same direction out of the exterior member 40. The positive electrode lead 31 and the negative electrode lead 32 are formed using, for example, metallic material such as aluminum, copper, nickel, and stainless steel. These metallic materials are formed into, for example, a thin plate or a mesh.

The exterior member 40 is formed using, for example, a rectangular aluminum laminate film that includes a nylon film, an aluminum foil, and a polyethylene film laminated in this order. For example, the exterior member 40 is structured by being fused or bonded with an adhesive at the peripheries with the polyethylene film side facing the wound electrode unit 30. An adhesive film 41 that prevents entry of ambient air is inserted between the exterior member 40 and the positive and negative electrode leads 31 and 32. The adhesive film 41 is configured from materials adherent to the positive and negative electrode leads 31 and 32. Examples include polyolefin resins such as polyethylene, polypropylene, modified-polyethylene, and modified-polypropylene.

The exterior member 40 may be configured from laminate films of other laminate structures, instead of the aluminum laminate film, or from a polypropylene or other polymer films, or metal films.

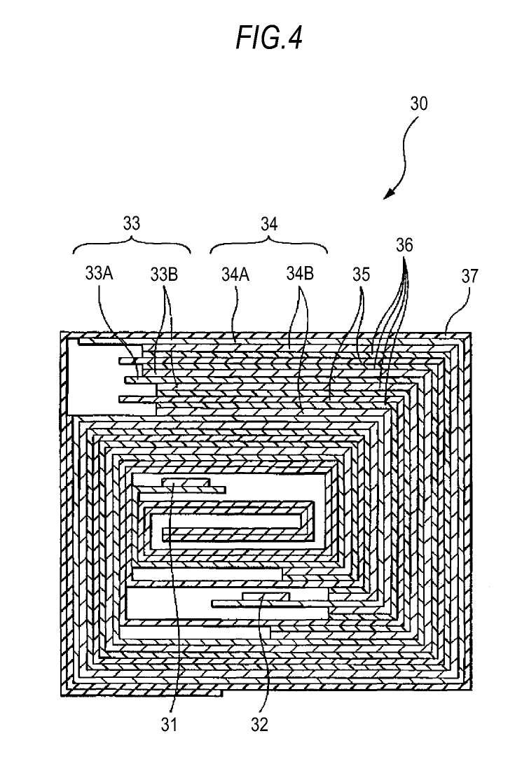

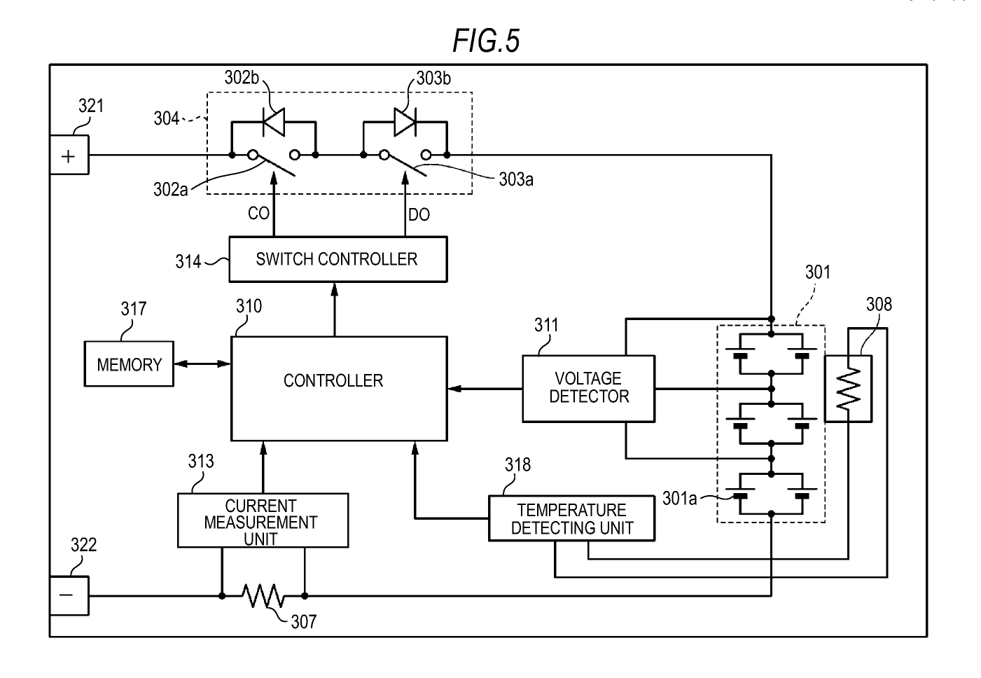

FIG. 4 is a cross sectional view of the wound electrode unit 30 of FIG. 3 along the line IV-IV. The wound electrode unit 30 is a wound unit of a positive electrode 33 and a negative electrode 34 laminated via a separator 35 and an electrolyte layer 36. The outermost periphery of the wound electrode unit 30 is protected by a protective tape 37.

The positive electrode 33 is structured to include, for example, a positive electrode active material layer 33B on one side or on the both sides of a positive electrode collector 33A. The negative electrode 34 is structured to include, for example, a negative electrode active material layer 34B on one side or on the both sides of a negative electrode collector 34A. The negative electrode active material layer 34B is disposed facing the positive electrode active material layer 33B. The positive electrode collector 33A, the positive electrode active material layer 33B, the negative electrode collector 34A, the negative electrode active material layer 34B, and the separator 35 are configured the same way as the positive electrode collector 21A, the positive electrode active material layer 21B, the negative electrode collector 22A, the negative electrode active material layer 22B, and the separator 23 of First Embodiment.

The electrolyte layer 36 is a gelatinous layer that includes the electrolytic solution containing the phosphorus compound, and a polymer compound that holds the electrolytic solution. The gel electrolyte layer 36 is preferred, because it can provide high ion conductivity, and can prevent battery leakage. The composition of the electrolytic solution (specifically, for example, the solvent, the electrolyte salt, and the phosphorus compound) is the same as that in the secondary battery of First Embodiment. Examples of the polymer compound include polyacrylonitrile, polyvinylidene fluoride, a vinylidene fluoride-hexafluoropropylene copolymer, polytetrafluoroethylene, polyhexafluoropropylene, polyethylene oxide, polypropylene oxide, polyphosphazene, polysiloxane, polyvinyl acetate, polyvinyl alcohol, polymethylmethacrylate, polyacrylic acid, polymethacrylic acid, styrene-butadiene rubber, nitrile-butadiene rubber, polystyrene, and polycarbonate. Particularly preferred from the standpoint of electrochemical stability are polyacrylonitrile, polyvinylidene fluoride, polyhexafluoropropylene, and polyethylene oxide.

[Battery Producing Method]

The following describes an example of a method for producing the nonaqueous electrolytic secondary battery of Second Embodiment of the present application.

First, a precursor solution containing the solvent, the electrolyte salt, the additive phosphorus compound, the polymer compound, and a mixed solvent is applied to the positive electrode 33 and the negative electrode 34. The mixed solvent is then evaporated to form the electrolyte layer 36. Then, the positive electrode lead 31 and the negative electrode lead 32 are welded to the end of the positive electrode collector 33A and the end of the negative electrode collector 34A, respectively. The positive electrode 33 and the negative electrode 34 with the electrolyte layer 36 are then laminated via the separator 35, and wound along the longitudinal direction. The protective tape 37 is then bonded to the outermost periphery to fabricate the wound electrode unit 30. Finally, the wound electrode unit 30 is placed between, for example, a pair of exterior members 40, and sealed therein by bonding the exterior members 40 at the peripheries by, for example, heatfusion. The adhesive film 41 is inserted between the positive and negative electrode leads 31 and 32 and the exterior members 40. This completes the secondary battery illustrated in FIGS. 3 and 4.

Alternatively, the secondary battery may be produced as follows. The positive electrode 33 and the negative electrode 34 are produced as above, and the positive electrode lead 31 and the negative electrode lead 32 are attached to the positive electrode 33 and the negative electrode 34. Then, the positive electrode 33 and the negative electrode 34 are wound with the separator 35 laminated in between, and the protective tape 37 is bonded to the outermost periphery to form a precursor wound unit of the wound electrode unit 30. The wound unit is then placed between a pair of exterior members 40, which are then heatfused at the peripheries, leaving one side open. As a result, the wound unit is housed in the bag of the exterior member 40. Then, an electrolyte composition is prepared that includes the solvent, the electrolyte salt, the additive phosphorus compound, the raw material monomer of the polymer compound, a polymerization initiator, and optional materials such as a polymerization inhibitor, and the electrolyte composition is injected into the exterior member 40.

After injecting the electrolyte composition in the exterior member 40, the opening of the exterior member 40 is heatfused in a vacuum atmosphere. The monomer is then heat polymerized into the polymer compound, and the gel electrolyte layer 36 is formed. This completes the secondary battery illustrated in FIG. 3.

The nonaqueous electrolytic secondary battery of Second Embodiment is equally advantageous and effective as the nonaqueous electrolytic secondary battery of First Embodiment.

### 3. Third Embodiment

(Examples of Battery Pack)

FIG. 5 is a block diagram representing an exemplary circuit configuration of a battery pack to which the nonaqueous electrolytic secondary battery (hereinafter, also referred to as “secondary battery”) of the embodiment of the present application is applied. The battery pack includes an assembled battery 301; an exterior; switch unit 304 including a charge control switch 302a and a discharge control switch 303a; a current detecting resistor 307, a temperature detecting element 308, and a controller 310.

The battery pack also includes a positive electrode terminal 321 and a negative electrode terminal 322. During the charging process, the positive electrode terminal 321 and the negative electrode terminal 322 are connected to the positive electrode terminal and the negative electrode terminal, respectively, of the charger for charging. During use in an electronic device, the positive electrode terminal 321 and the negative electrode terminal 322 are connected to the positive electrode terminal and the negative electrode terminal, respectively, of the electronic device for discharge.

The assembled battery 301 is configured from a plurality of secondary batteries 301a connected to each other in series and/or in parallel. The secondary batteries 301a are realized by the secondary battery of the embodiment of the present application. Note that, in the example represented in FIG. 5, a total of six secondary batteries 301a are connected in a two parallel series and three serial series (2P3S) configuration. However, the batteries may be connected in any way, as in n parallel series and m serial series (n and m are integers).

The switch unit 304 includes the charge control switch 302a and a diode 302b, and the discharge control switch 303a and a diode 303b, and is controlled by the controller 310. The diode 302b is reverse biased for the charge current flowing into the assembled battery 301 from the positive electrode terminal 321, and forward biased for the discharge current flowing into the assembled battery 301 from the negative electrode terminal 322. The diode 303b is forward biased for the charge current, and reverse biased for the discharge current. The switch unit, provided on the positive side in this example, may be provided on the negative side.

The charge and discharge controller controls the charge control switch 302a, turning it off upon the battery voltage reaching the overcharge detection voltage, and blocking the flow of the charge current into the current path of the assembled battery 301. Once the charge control switch is turned off, discharge is possible only via the diode 302b. The controller 310 also controls the charge control switch 302a, turning it off when there is a large current flow during the charging process, and blocking the charge current from flowing into the current path of the assembled battery 301.

The controller 310 controls the discharge control switch 303a, turning it off upon the battery voltage reaching the overdischarge detection voltage, and blocking the flow of the discharge current into the current path of the assembled battery 301. Once the discharge control switch 303a is turned off, charging is possible only via the diode 303b. The controller 310 also controls the discharge control switch 303a, turning it off when there is a large current flow during the discharge, and blocking the discharge current from flowing into the current path of the assembled battery 301.

The temperature detecting element 308 is, for example, a thermistor, and is provided near the assembled battery 301. The temperature detecting element 308 measures the temperature of the assembled battery 301, and sends the measured temperature to the controller 310. A voltage detector 311 measures the voltage of the assembled battery 301, and the voltage of each secondary battery 301a forming the assembled battery 301, and sends the measured voltage to the controller 310 after A/D conversion. A current measurement unit 313 measures a current using the current detecting resistor 307, and sends the measured current to the controller 310.

A switch controller 314 controls the charge control switch 302a and the discharge control switch 303a of the switch unit 304 based on the input voltage and current from the voltage detector 311 and the current measurement unit 313. The switch controller 314 sends a control signal to the switch unit 304 when any of the voltages of the secondary batteries 301a reaches or falls below the overcharge detection voltage or overdischarge detection voltage, or when there is an abrupt large current flow, so as to prevent overcharge and overdischarge, and overcurrent charge and discharge.

For example, when the secondary battery 301a is a lithium ion secondary battery, the overcharge detection voltage is set at, for example, 4.20 V ±0.05 V, and the overdischarge detection voltage at, for example, 2.4 V ±0.1V.

A semiconductor switch, for example, such as a MOSFET may be used as the charge and discharge switch. In this case, the parasitic diodes of the MOSFET serve as the diodes 302b and 303b. When a P-channel-type FET is used as the charge and discharge switch, the switch controller 314 supplies control signals DO and CO to the gates of the charge control switch 302a and the discharge control switch 303a, respectively. When realized as P-channel-type switches, the charge control switch 302a and the discharge control switch 303a turn on at a gate potential lower than the source potential by at least a predetermined voltage. Specifically, during the normal charging and discharge operations, the control signals CO and DO are brought to low level, and the charge control switch 302a and the discharge control switch 303a are turned on.

For example, when there is overcharge or overdischarge, the control signals CO and DO are brought to high level, and the charge control switch 302a and the discharge control switch 303a are turned off.

A memory 317 is a RAM or ROM, and, for example, a non-volatile memory such as an EPROM (Erasable Programmable Read Only Memory) is used. The memory 317 stores information such as the numerical values computed in the controller 310, and the battery internal resistance values in the initial state of the secondary batteries 301a measured during the production. The memory 317 may be rewritten as appropriate. (The full charge capacity of the secondary batteries 301a may be stored to enable, for example, calculations of the remaining capacity with the controller 310.)

A temperature detecting unit 318 measures a temperature using the temperature detecting element 308, and performs other operations, including control of the charge and discharge in case of abnormal heating, and calibrations in the calculations of the remaining capacity.

### 4. Fourth Embodiment

The nonaqueous electrolytic secondary battery, and the battery pack using it can be installed in, for example, devices such as electronic devices, electric vehicles, and power storage devices, or can be used to supply power to these devices.

Examples of the electronic devices include laptop personal computers, PDAs (personal digital assistance), cell phones, cordless handsets, videos, digital still cameras, electronic books, electronic dictionaries, music players, radios, headphones, gaming machines, navigation systems, memory cards, pacemakers, hearing aids, electric power tools, electric shavers, refrigerators, air conditioners, televisions, stereos, water heaters, microwave ovens, dishwashers, washing machines, driers, illumination equipment, toys, medical equipment, robots, load conditioners, and traffic lights.

Examples of the electric vehicles include railway cars, caddie carts, mobility scooters, and electric automobiles (including hybrid cars). The nonaqueous electrolytic secondary battery and the battery pack can be used as the driving power supply or auxiliary power supply for these vehicles.

Examples of the power storage devices include power storage power supplies for houses and buildings, or for power-generating facilities.

Among these application examples, the following describes a specific example of a power storage system using a power storage device to which the nonaqueous electrolytic secondary battery of the embodiment of the present application is applied.

The power storage system may be configured, for example, as follows. A first power storage system is a power storage system that charges a power storage device with a power generating unit that generates power from renewable energy. A second power storage system is a power storage system that includes a power storage device, and that supplies power to an electronic device connected to the power storage device. A third power storage system is an electronic device that receives power from the power storage device. These power storage systems are realized as systems for efficiently supplying power in collaboration with an external power supply network.

A fourth power storage system is an electric vehicle that includes a converter for converting the supplied power from a power storage device into the driving power of a vehicle, and a control unit that processes information concerning vehicle control based on information concerning the power storage device. A fifth power storage system is a power system that includes a power information transmitting/receiving unit for transmitting and receiving signals to and from other devices via a network, and that controls the charge and discharge of the power storage device based on the information received by the transmitting/receiving unit. A sixth power storage system is a power storage system that receives power from the power storage device, or supplies power to the power storage device from a power generating unit or a power grid. The power storage system is described below.

(Home Power Storage System as Application Example)

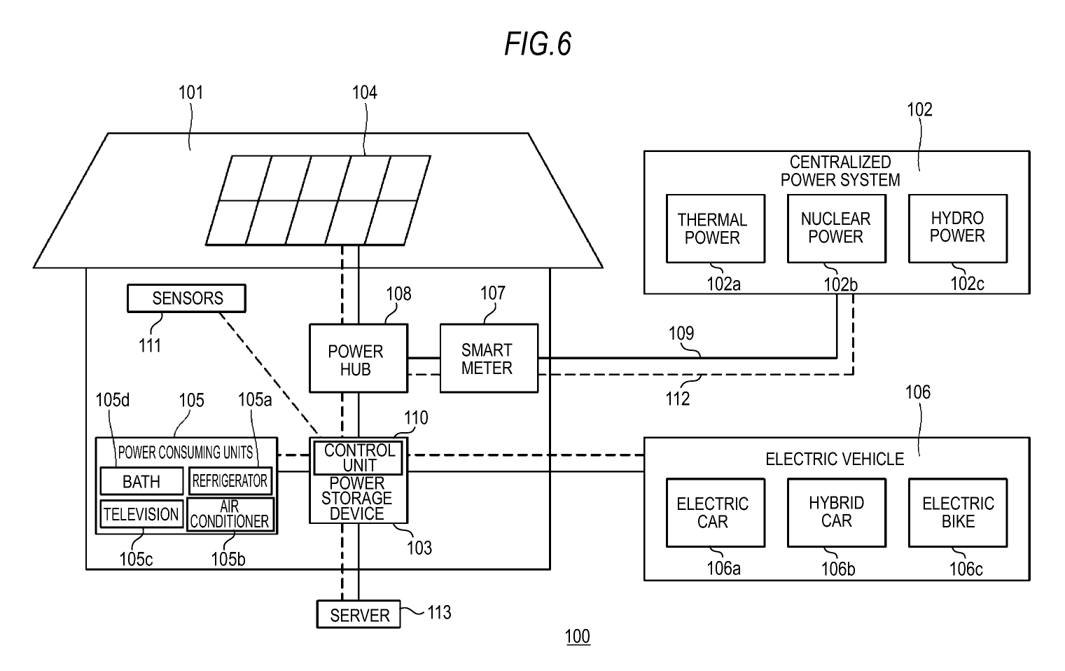

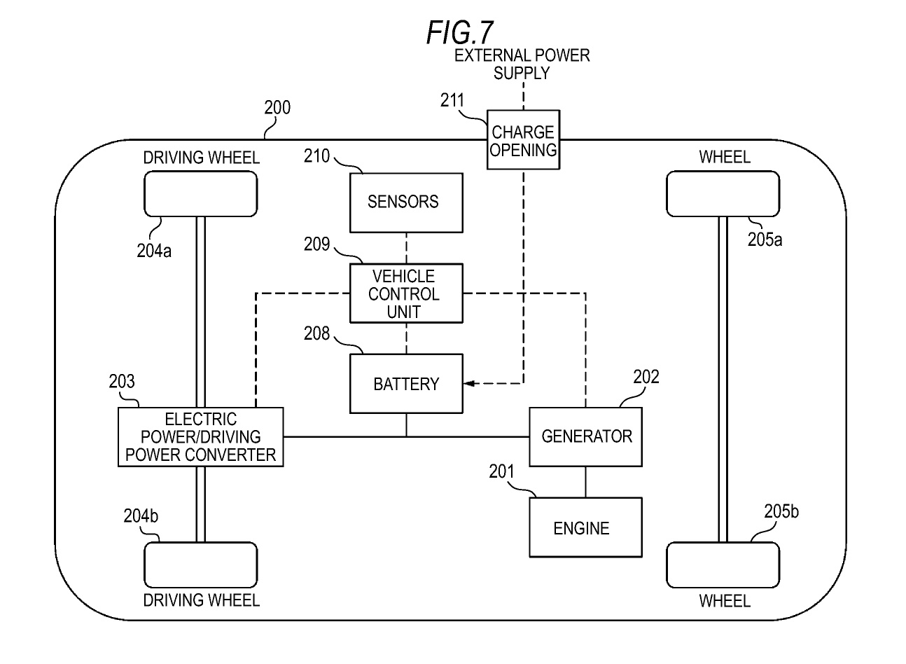

A home power storage system using a power storage device that uses the nonaqueous electrolytic secondary battery of the embodiment of the present application is described below as an application example, with reference to FIG. 6. For example, in a power storage system 100 for a house 101, power is supplied to a power storage device 103 from a centralized power system 102 such as a thermal power 102a, a nuclear power 102b, and a hydro power 102c via, for example, a power grid 109, information network 112, a smart meter 107, and a power hub 108. Power is also supplied to the power storage device 103 from an independent power supply such as a home power generating unit 104. The power storage device 103 stores the supplied power. The power storage device 103 is used to feed power used in the house 101. Aside from the house 101, the same power storage system also can be used for buildings.

The house 101 is equipped with the power generating unit 104, power consuming units 105, the power storage device 103, a control unit 110 for controlling various units, the smart meter 107, and sensors 111 for acquiring a variety of information. These units are connected to one another via the power grid 109 and the information network 112. The power generating unit 104 is realized by, for example, a solar cell, or a fuel cell, and the generated power is supplied to the power consuming units 105 and/or to the power storage device 103. The power consuming units 105 include a refrigerator 105a, an air conditioner 105b, a television receiver 105c, and a bath 105d. The power consuming units 105 also includes an electric vehicle 106. The electric vehicle 106 is an electric car 106a, a hybrid car 106b, or an electric bike 106c.

The nonaqueous electrolytic secondary battery of the embodiment of the present application is applied to the power storage device 103. The nonaqueous electrolytic secondary battery of the embodiment of the present application may be configured from, for example, the lithium ion secondary battery described above. The smart meter 107 functions to measure the amounts of the commercial power used, and send the measured amounts to a power company. The power grid 109 may include one or more of a DC power feed, an AC power feed, and a non-contact power feed.

The sensors 111 include, for example, a motion sensor, an illuminance sensor, an object detection sensor, a power consumption sensor, a vibration sensor, a contact sensor, a temperature sensor, and an infrared sensor. The information acquired by the sensors 111 is sent to the control unit 110. The information from the sensors 111 can be used to grasp parameters such as weather conditions and human conditions, and allows the power consuming units 105 to be automatically controlled to minimize energy consumption. The control unit 110 can send information concerning the house 101 to, for example, an external power company via the Internet.

The power hub 108 is provided for processes such as branching of power lines, and DC/AC conversion. The information network 112 connected to the control unit 110 may communicate by using various communication methods, including methods using a communications interface such as UART (Universal Asynchronous Receiver-Transceiver: a transmitting/receiving circuit for asynchronous serial communications), and methods using a radio communication standard sensor network, such as Bluetooth, ZigBee, and Wi-Fi. The Bluetooth is applicable to multimedia communications, and enables point-to-multipoint communications. ZigBee uses an IEEE (Institute of Electrical and Electronics Engineers) 802.15.4 physical layer. IEEE 802.15.4 is the name used to refer to short distance radio network standards called PAN (Personal Area Network) or W (Wireless) PAN.

The control unit 110 is connected to an external server 113. The server 113 may be administered by any of the house 101, a power company, and a service provider. Examples of the information sent and received by the server 113 include power consumption information, life pattern information, power rate, weather information, natural disaster information, and information concerning power trade. The information may be transmitted and received by a home power consuming unit (for example, a television receiver), or by external devices (for example, such as a mobile phone). Further, the information may be displayed by devices having display functions, for example, such as a television receiver, a mobile phone, and a PDA (Personal Digital Assistants).

The control unit 110 that controls the other units is configured from, for example, a CPU (Central Processing Unit), a RAM (Random Access Memory), and a ROM (Read Only Memory), and is installed in the power storage device 103 in this example. The control unit 110 is connected to the power storage device 103, the home power generating unit 104, the power consuming units 105, the sensors 111, and the server 113 via the information network 112, and functions to adjust, for example, the amount of the commercial power used, and the amount of generated power. The control unit 110 may also have other functions, including a power trade function in the power market.

As described above, the power storage device 103 can store not only the power from the centralized power system 102 including the thermal power 102a, the nuclear power 102b, and the hydro power 102c, but the power generated by the home power generating unit 104 (solar power, wind power). In this way, the amount of outgoing power can be controlled constant, or controlled to discharge only in necessary amounts, even when there are fluctuations in the power generated by the home power generating unit 104. For example, the power obtained from the solar power may be stored in the power storage device 103, whereas the power supplied at a late-hour discount rate may be stored in the power storage device 103 during the night time, and the stored power in the power storage device 103 may be discharged during the day time in which the power is supplied at higher rates.

The control unit 110, described as being installed in the power storage device 103 in this example, may be installed in the smart meter 107, or may be configured alone. Further, the power storage system 100 may be used for more than one home in an apartment, or for homes in detached housing.

(Vehicle Power Storage System as Application Example)

A vehicle power storage system using the embodiment of the present application is described below as an application example, with reference to FIG. 7. FIG. 7 schematically represents an exemplary configuration of a hybrid vehicle using a series hybrid system based on the present application. The series hybrid system is a car that runs on power converted by an electric power/driving power converter, using the power generated by a generator driven by an engine, or using the power generated by the generator and stored in a battery.

A hybrid vehicle 200 includes an engine 201, a generator 202, an electric power/driving power converter 203, a driving wheel 204a, a driving wheel 204b, a wheel 205a, a wheel 205b, a battery 208, a vehicle control unit 209, sensors 210, and a charge opening 211. The nonaqueous electrolytic secondary battery of the embodiment of the present application is applied to the battery 208.

The hybrid vehicle 200 uses the electric power/driving power converter 203 as the power source. An example of the electric power/driving power converter 203 is a motor. The power from the battery 208 activates the electric power/driving power converter 203, and the torque of the electric power/driving power converter 203 is transmitted to the driving wheels 204a and 204b. Note that a direct current-alternate current (DC-AC) converter or a reverse (AC-DC) converter may be used at necessary locations to make the electric power/driving power converter 203 an alternate current motor or a direct current motor. The sensors 210 control the rotation speed of the engine, or the throttle valve opening (throttle opening; not illustrated) via the vehicle control unit 209. The sensors 210 include a velocity sensor, an acceleration sensor, and an engine rotation speed sensor.

The torque of the engine 201 transmits to the generator 202, and the power generated by the generator 202 using the torque may be accumulated in the battery 208.

Deceleration of the hybrid vehicle 200 by braking with a braking mechanism (not illustrated) causes the deceleration resistance to add to the torque of the electric power/driving power converter 203, and the regenerative power generated by the electric power/driving power converter 203 using the torque is accumulated in the battery 208.

By being connected to a power supply external to the hybrid vehicle 200, the battery 208 may receive and accumulate the power supplied from the external power supply through the charge opening 211 provided as an inlet.

Though not illustrated, an information processor that processes information concerning vehicle control based on information concerning the secondary battery may be provided. Examples of such information processors include an information processor that displays the remaining battery level based on information concerning the remaining amount of the battery.

In this example, the series hybrid car was described that runs on a motor using the power generated by the generator driven by the engine, or using the power generated by the generator and accumulated in the battery. However, the present application is also applicable to a parallel hybrid car that uses both the engine and motor outputs as the driving source, and that runs by appropriately switching three different modes that use only the engine, only the motor, and both the engine and the motor. Further, the present application is effectively applicable also to electric vehicles that run only on a driving motor without using an engine.

### EXAMPLES

The following describes the present application in more detail based on Examples. The present application is not limited by the descriptions of the following Examples.

### Example 1-1

First, the positive electrode was fabricated. Specifically, lithium carbonate (Li₂CO₃) and cobalt carbonate (CoCO₃) were mixed at a 0.5:1 molar ratio, and calcined in air at 900° C. for 5 hours to obtain a lithium-cobalt composite oxide (LiCoO₂). Then, the positive electrode active material lithium-cobalt composite oxide (91 parts by mass), the conductive agent graphite (6 parts by mass), and the binder polyvinylidene fluoride (3 parts by mass) were mixed to obtain a positive electrode mixture, and the mixture was dispersed in N-methyl-2-pyrrolidone to obtain a paste-like positive electrode mixture slurry. Thereafter, the positive electrode mixture slurry was applied onto the both surfaces of a positive electrode collector realized by a belt-like aluminum foil (12 μm thick), dried, and compression molded with a roller press machine to form a positive electrode active material layer. The positive electrode lead, made of aluminum, was then welded to one end of the positive electrode collector.

The negative electrode was fabricated as follows. First, an artificial graphite powder (negative electrode active material; 97 parts by mass), and polyvinylidene fluoride (binder; 3 parts by mass) were mixed to obtain a negative electrode mixture. The negative electrode mixture was then dispersed in N-methyl-2-pyrrolidone to obtain a paste-like negative electrode mixture slurry. Then, the negative electrode mixture slurry was applied to the both surfaces of a negative electrode collector realized by a belt-like copper foil (15 μm thick), and a negative electrode active material layer was formed by compression molding using a roller press machine. Then, a nickel negative electrode lead was attached to one end of the negative electrode collector.

Then, the positive electrode, a separator realized by a microporous polypropylene film (25 μm thick), and the negative electrode were laminated in this order, and wound multiple times in spirals, and the terminating end was fixed with an adhesive tape to form a wound electrode unit. Thereafter, a nickel-plated iron battery canister was prepared. With the wound electrode unit sandwiched between a pair of insulating plates, the negative electrode lead and the positive electrode lead were welded to the battery canister and the safety valve mechanism, respectively, and the wound electrode unit was housed inside the battery canister. Then, an electrolytic solution was injected into the battery canister using a reduced pressure method. The electrolytic solution was obtained by adding the organophosphate compound of structural formula (41) in 0.005 mass % to a 20:65:15 (mass ratio) mixture of ethylene carbonate (EC), dimethyl carbonate (DMC), and LiPF₆. The total content of the ethylene carbonate (EC), dimethyl carbonate (DMC), LiPF₆, and organophosphate compound was 100 mass %.

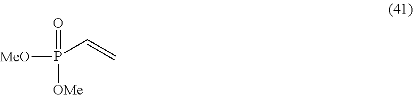

Here, the organophosphate compound represented by structural formula (41) is an example of the organophosphate compound of general formula (II), and the vinyl group, the methyl group and the methyl group in the structural formula (41) are specific examples of R4, R5, and R6, respectively, in general formula (II).

Thereafter, the battery canister was swaged via an asphalt-coated gasket to fix the safety valve mechanism, the heat-sensitive resistive element, and the battery lid. As a result, the battery canister was sealed air-tight, and the cylindrical nonaqueous electrolytic secondary battery was completed.

### Example 1-2

A nonaqueous electrolytic secondary battery was fabricated in the same manner as in Example 1-1, except that the content of the organophosphate compound of structural formula (41) was changed to 0.01 mass %.

### Example 1-3

A nonaqueous electrolytic secondary battery was fabricated in the same manner as in Example 1-1, except that the content of the organophosphate compound of structural formula (41) was changed to 0.1 mass %.

### Example 1-4

A nonaqueous electrolytic secondary battery was fabricated in the same manner as in Example 1-1, except that the content of the organophosphate compound of structural formula (41) was changed to 0.5 mass %.

### Example 1-5

A nonaqueous electrolytic secondary battery was fabricated in the same manner as in Example 1-1, except that the content of the organophosphate compound of structural formula (41) was changed to 1 mass %.

### Example 1-6

A nonaqueous electrolytic secondary battery was fabricated in the same manner as in Example 1-1, except that the content of the organophosphate compound of structural formula (41) was changed to 5 mass %.

### Example 1-7

A nonaqueous electrolytic secondary battery was fabricated in the same manner as in Example 1-1, except that the content of the organophosphate compound of structural formula (41) was changed to 10 mass %.

### Examples 2-1 to 2-7

Nonaqueous electrolytic secondary batteries were fabricated in the same manner as in Examples 1-1 to 1-7, except that the organophosphate compound of structural formula (42) was used instead of the organophosphate compound of structural formula (41).

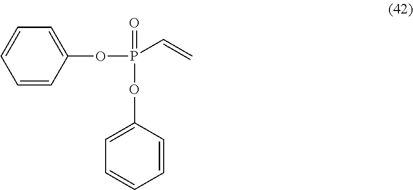 [SMILES: C=CP(=O)(Oc1ccccc1)Oc1ccccc1]

Here, the organophosphate compound represented by structural formula (42) is an example of the organophosphate compound of general formula (II), and the vinyl group, the phenyl group and the phenyl group in the structural formula (42) are specific examples of R4, R5, R6, respectively, in general formula (II).

### Examples 3-1 to 3-7

Nonaqueous electrolytic secondary batteries were fabricated in the same manner as in Examples 1-1 to 1-7, except that the organophosphate compound of structural formula (43) was used instead of the organophosphate compound of structural formula (41).

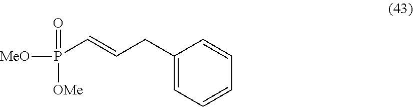 [SMILES: COP(=O)(/C=C/Cc1ccccc1)OC]

Here, the organophosphate compound represented by structural formula (43) is an example of the organophosphate compound of general formula (II), and the group in which the terminal hydrogen atom of the prop-1-en-1-yl group is replaced with a phenyl group, the methyl group and the methyl group in the structural formula (43) are specific examples of R4, R5, and R6, respectively, in general formula (II).

### Examples 4-1 to 4-7

Nonaqueous electrolytic secondary batteries were fabricated in the same manner as in Examples 1-1 to 1-7, except that the organophosphate compound of structural formula (44) was used instead of the organophosphate compound of structural formula (41).

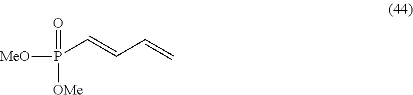

Here, the organophosphate compound represented by structural formula (44) is an example of the organophosphate compound of general formula (II), and the buta-1,3-dien-1-yl group, the methyl group and the methyl group in the structural formula (44) are specific example of R4, R5, and R6, respectively, in general formula (II).

### Examples 5-1 to 5-7

Nonaqueous electrolytic secondary batteries were fabricated in the same manner as in Examples 1-1 to 1-7, except that the organophosphate compound of structural formula (45) was used instead of the organophosphate compound of structural formula (41).

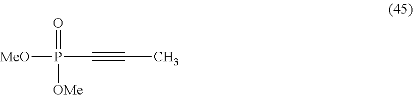

Here, the organophosphate compound represented by structural formula (45) is an example of the organophosphate compound of general formula (II), and the prop-1-yn-1-yl group, the methyl group and the methyl group in the structural formula (45) are specific examples of R4, R5, and R6, respectively, in general formula (II).

### Examples 6-1 to 6-7

Nonaqueous electrolytic secondary batteries were fabricated in the same manner as in Examples 1-1 to 1-7, except that the organophosphate compound of structural formula (46) was used instead of the organophosphate compound of structural formula (41).

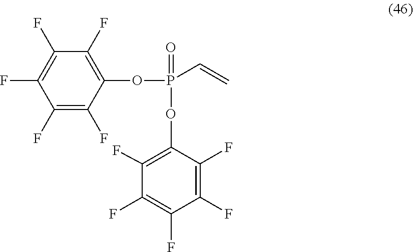 [SMILES: C=CP(=O)(Oc1c(F)c(F)c(F)c(F)c1F)Oc1c(F)c(F)c(F)c(F)c1F]

Here, the organophosphate compound represented by structural formula (46) is an example of the organophosphate compound of general formula (II), and the vinyl group, the group which is a phenyl group whose hydrogen atoms are all replaced with a fluorine atom and the group which is a phenyl group whose hydrogen atoms are all replaced with a fluorine atom in the structural formula (46) are specific examples of R4, R5, and R6, respectively, in general formula (II).

### Examples 7-1 to 7-7

Nonaqueous electrolytic secondary batteries were fabricated in the same manner as in Examples 1-1 to 1-7, except that the organophosphate compound of structural formula (47) was used instead of the organophosphate compound of structural formula (41).

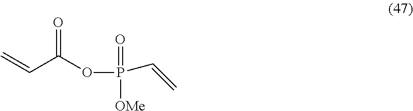

Here, the organophosphate compound represented by structural formula (47) is an example of the organophosphate compound of general formula (II), and the vinyl group, the methyl group, and the group which is an allyl group whose methylene group is replaced with a carbonyl group in the structural formula (47) are specific examples of R4, R5, and R6, respectively, in general formula (II).

### Examples 8-1 to 8-7

Nonaqueous electrolytic secondary batteries were fabricated in the same manner as in Examples 1-1 to 1-7, except that the organophosphate compound of structural formula (48) was used instead of the organophosphate compound of structural formula (41).

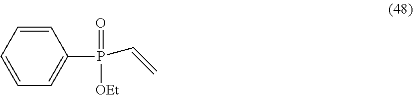

Here, the organophosphate compound represented by structural formula (48) is an example of the organophosphate compound of general formula (III), and the vinyl group, the ethyl group, and the phenyl group in the structural formula (48) are specific examples of R7, R8, and R9, respectively, in general formula (III).

### Examples 9-1 to 9-7

Nonaqueous electrolytic secondary batteries were fabricated in the same manner as in Examples 1-1 to 1-7, except that the organophosphate compound of structural formula (49) was used instead of the organophosphate compound of structural formula (41).

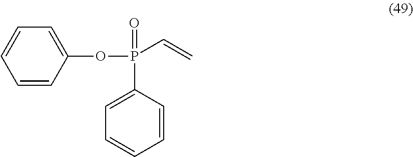 [SMILES: C=CP(=O)(Oc1ccccc1)c1ccccc1]

Here, the organophosphate compound represented by structural formula (49) is an example of the organophosphate compound of general formula (III), and the vinyl group, the phenyl group and the phenyl group in the structural formula (49) are specific examples of R7, R8, and R9, respectively, in general formula (III).

### Examples 10-1 to 10-7

Nonaqueous electrolytic secondary batteries were fabricated in the same manner as in Examples 1-1 to 1-7, except that the organophosphate compound of structural formula (50) was used instead of the organophosphate compound of structural formula (41).

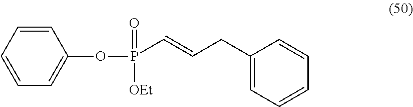 [SMILES: CCOP(=O)(/C=C/Cc1ccccc1)Oc1ccccc1]

Here, the organophosphate compound represented by structural formula (50) is an example of the organophosphate compound of general formula (III), and the group in which the terminal hydrogen atom of the prop-1-en-1-yl group is replaced with a phenyl group, and the ethyl and phenyl groups in the structural formula (50) are specific examples of R7, R8, and R9, respectively, in general formula (III).

### Examples 11-1 to 11-7

Nonaqueous electrolytic secondary batteries were fabricated in the same manner as in Examples 1-1 to 1-7, except that the organophosphate compound of structural formula (51) was used instead of the organophosphate compound of structural formula (41).

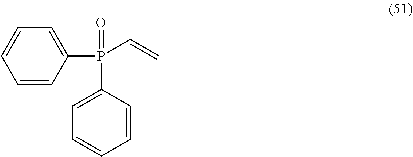 [SMILES: C=CP(=O)(c1ccccc1)c1ccccc1]

Here, the organophosphate compound represented by structural formula (51) is an example of the organophosphate compound of general formula (I), and the vinyl group, the phenyl group and the phenyl group in the structural formula (51) are specific examples of R1, R2, and R3, respectively, in general formula (I).

### Comparative Example 1-1

A nonaqueous electrolytic secondary battery was fabricated in the same manner as in Example 1-1, except that a 20:65:15 (mass ratio) mixture of ethylene carbonate (EC), dimethyl carbonate (DMC), and LiPF₆ was used as the electrolytic solution.

### Comparative Example 1-2

A nonaqueous electrolytic secondary battery was fabricated in the same manner as in Example 1-5, except that the trimethyl phosphite represented by structural formula (52) was used instead of the organophosphate compound of structural formula (41).

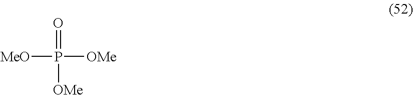

### Comparative Example 1-3

A nonaqueous electrolytic secondary battery was fabricated in the same manner as in Example 1-5, except that the triphenyl phosphite represented by structural formula (53) was used instead of the organophosphate compound of structural formula (41).

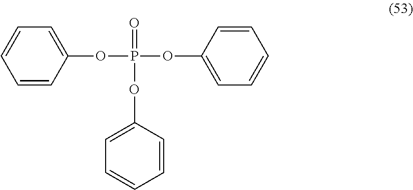 [SMILES: O=P(Oc1ccccc1)(Oc1ccccc1)Oc1ccccc1]

### Comparative Example 1-4

A nonaqueous electrolytic secondary battery was fabricated in the same manner as in Example 1-5, except that the methoxydiphenylphosphine represented by structural formula (54) was used instead of the organophosphate compound of structural formula (41).

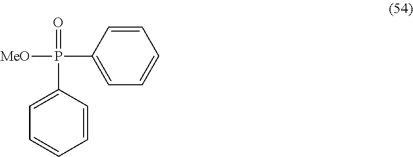 [SMILES: COP(=O)(c1ccccc1)c1ccccc1]

### Comparative Examples 1-5

A nonaqueous electrolytic secondary battery was fabricated in the same manner as in Example 1-5, except that the 2-ethoxy-5H-[1,2]oxaphosphole-2-oxide of structural formula (55) as a cyclic phosphinic ester was used instead of the organophosphate compound of structural formula (41).

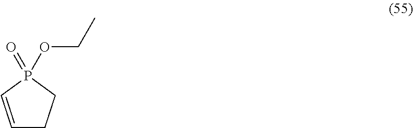

### Comparative Example 1-6

A nonaqueous electrolytic secondary battery was fabricated in the same manner as in Example 1-5, except that the vinyl phosphinic acid ethyl ester represented by structural formula (56) was used instead of the organophosphate compound of structural formula (41).

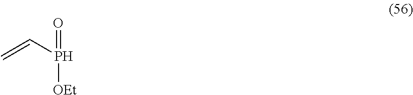

### Comparative Example 1-7

A nonaqueous electrolytic secondary battery was fabricated in the same manner as in Example 1-5, except that the vinyl phenyl phosphinic acid represented by structural formula (57) was used instead of the organophosphate compound of structural formula (41).

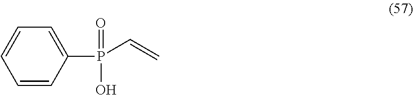

(Evaluation)

The nonaqueous electrolytic secondary batteries of Examples 1-1 to 11-7 and Comparative Examples 1-1 to 1-7 were evaluated for high-temperature characteristics, as follows. The results are presented in Tables 1 to 3.

(High-Temperature Storage Test)

First, the battery was subjected to 2 cycles of charge and discharge in a 23° C. atmosphere, and the discharge capacity after 2 cycles was determined. After being charged in the third cycle in a 23° C. atmosphere, the battery was stored in a 60° C. atmosphere for 2 weeks. Then, the battery was discharged in a 23° C. atmosphere, and the discharge capacity after the third cycle was determined Percentage remaining capacity was determined according to the following equation.

Percentage remaining capacity (%)=(discharge capacity after 3 cycles/discharge capacity after 2 cycles)×100

The battery was charged and discharged in a 23° C. atmosphere, and the discharge capacity after the fourth cycle was determined. Percentage capacity recovery was determined according to the following equation.

Percentage capacity recovery (%)=(discharge capacity after 4 cycles/discharge capacity after 2 cycles)×100

In the high-temperature storage test, a cycle of charge and discharge was performed under the following conditions. The battery was charged under a constant current of 1 mA/cm² until the battery voltage reached the predetermined voltage. The battery was further charged under the predetermined constant voltage until the current reached 0.02 mA/cm², and discharged at a constant current of 1 mA/cm² until the battery voltage reached 3 V.

(High-Temperature Cycle Test)

First, the battery was charged and discharged in 2 cycles in a 23° C. atmosphere. After another cycle of charge and discharge in a 45° C. atmosphere, the discharge capacity after the third cycle was measured. The charge and discharge was continued in the same atmosphere until the number of cycles reached 100, and the discharge capacity after 100 cycles was measured. Percentage remaining discharge capacity was determined according to the following equation.

Percentage remaining discharge capacity (%)=(discharge capacity after 100 cycles/discharge capacity after 3 cycles)×100

In the high-temperature cycle test, a cycle of charge and discharge was performed under the same conditions used in the high-temperature storage test.

Table 1 presents the evaluation results of the nonaqueous electrolytic secondary batteries of Examples 1-1 to 6-7.

TABLE 1

| | | Additive | | | | | |
|---|---|---|---|---|---|---|---|
| | | | | Amount | Percentage | Percentage | Percentage maintenance |
| | Negative | Structural | General | added | remaining | capacity | in high-temperature |
| | electrode | formula | formula | (mass %) | capacity (%) | recovery (%) | cycle (%) |
| Example 1-1 | Graphite | Formula | Formula | 0.005 | 58.5 | 63.3 | 42.5 |
| Example 1-2 | | (41) | (II) | 0.01 | 78.6 | 86.5 | 54.9 |
| Example 1-3 | | | | 0.1 | 87.6 | 92 2 | 72.5 |
| Example 1-4 | | | | 0.5 | 86.5 | 92.0 | 75.0 |
| Example 1-5 | | | | 1 | 88.0 | 90.8 | 74.5 |
| Example 1-6 | | | | 5 | 75.6 | 83.5 | 49.6 |
| Example 1-7 | | | | 10 | 50.2 | 55.8 | 36.1 |
| Example 2-1 | Graphite | Formula | Formula | 0.005 | 64.3 | 68.9 | 43.9 |
| Example 2-2 | | (42) | (II) | 0.01 | 80.2 | 87.3 | 56.8 |
| Example 2-3 | | | | 0.1 | 88.6 | 92.5 | 75.6 |
| Example 2-4 | | | | 0.5 | 88.5 | 93.1 | 79.2 |
| Example 2-5 | | | | 1 | 89.7 | 91.7 | 79.0 |
| Example 2-6 | | | | 5 | 80.1 | 82.5 | 49.3 |
| Example 2-7 | | | | 10 | 49.2 | 54.2 | 37.5 |
| Example 3-1 | Graphite | Formula | Formula | 0.005 | 57.6 | 63.4 | 43.1 |
| Example 3-2 | | (43) | (II) | 0.01 | 78.0 | 86.9 | 54.3 |
| Example 3-3 | | | | 0.1 | 86.5 | 91.5 | 71.3 |
| Example 3-4 | | | | 0.5 | 88.2 | 92.3 | 73.5 |
| Example 3-5 | | | | 1 | 88.9 | 91.5 | 73.9 |
| Example 3-6 | | | | 5 | 76.2 | 81.6 | 51.2 |
| Example 3-7 | | | | 10 | 49.2 | 54.6 | 36.5 |
| Example 4-1 | Graphite | Formula | Formula | 0.005 | 61.0 | 66.2 | 41.5 |
| Example 4-2 | | (44) | (II) | 0.01 | 80.1 | 87.5 | 52.4 |
| Example 4-3 | | | | 0.1 | 88.3 | 92.0 | 70.3 |
| Example 4-4 | | | | 0.5 | 89.5 | 92.4 | 71.5 |
| Example 4-5 | | | | 1 | 87.4 | 91.3 | 72.2 |
| Example 4-6 | | | | 5 | 73.2 | 80.7 | 45.6 |
| Example 4-7 | | | | 10 | 45.6 | 50.4 | 36.3 |
| Example 5-1 | Graphite | Formula | Formula | 0.005 | 61.3 | 65.3 | 46.5 |
| Example 5-2 | | (45) | (II) | 0.01 | 80.1 | 89.3 | 56.0 |
| Example 5-3 | | | | 0.1 | 87.6 | 93.4 | 70.6 |
| Example 5-4 | | | | 0.5 | 88.3 | 92.6 | 71.6 |
| Example 5-5 | | | | 1 | 88.3 | 91.5 | 71.1 |
| Example 5-6 | | | | 5 | 74.6 | 80.9 | 48.6 |
| Example 5-7 | | | | 10 | 49.3 | 53.6 | 39.2 |
| Example 6-1 | Graphite | Formula | Formula | 0.005 | 64.3 | 68.6 | 45.8 |
| Example 6-2 | | (46) | (II) | 0.01 | 81.5 | 90.4 | 57.0 |
| Example 6-3 | | | | 0.1 | 89.1 | 93.3 | 70.2 |
| Example 6-4 | | | | 0.5 | 90.1 | 93.8 | 72.1 |
| Example 6-5 | | | | 1 | 89.7 | 91.3 | 72.5 |
| Example 6-6 | | | | 5 | 75.6 | 82.6 | 49.4 |
| Example 6-7 | | | | 10 | 51.3 | 54.6 | 40.0 |

Table 2 presents the evaluation results of the nonaqueous electrolytic secondary batteries of Examples 7-1 to 11-7 and Comparative Examples 1-1 to 1-7.

TABLE 2

| | | Additive | | | | | |
|---|---|---|---|---|---|---|---|
| | | | | Amount | Percentage | Percentage | Percentage maintenance |
| | Negative | Structural | General | added | remaining | capacity | in high-temperature |
| | electrode | formula | formula | (mass %) | capacity (%) | recovery (%) | cycle (%) |
| Example 7-1 | Graphite | Formula | Formula | 0.005 | 52.5 | 54.5 | 40.1 |
| Example 7-2 | | (47) | (II) | 0.01 | 65.4 | 67.8 | 50.4 |
| Example 7-3 | | | | 0.1 | 75.1 | 78.4 | 55.4 |
| Example 7-4 | | | | 0.5 | 76.1 | 78.5 | 56.2 |
| Example 7-5 | | | | 1 | 72.1 | 70.1 | 53.7 |
| Example 7-6 | | | | 5 | 61.1 | 65.8 | 43.2 |
| Example 7-7 | | | | 10 | 41.5 | 44.5 | 39.4 |
| Example 8-1 | Graphite | Formula | Formula | 0.005 | 57.3 | 65.2 | 44.7 |
| Example 8-2 | | (48) | (III) | 0.01 | 79.1 | 86.3 | 54.3 |
| Example 8-3 | | | | 0.1 | 87.6 | 91.6 | 73.2 |
| Example 8-4 | | | | 0.5 | 86.0 | 92.1 | 76.6 |
| Example 8-5 | | | | 1 | 88.5 | 92.0 | 75.3 |
| Example 8-6 | | | | 5 | 75.3 | 84.1 | 50.3 |
| Example 8-7 | | | | 10 | 49.9 | 55.0 | 35.9 |
| Example 9-1 | Graphite | Formula | Formula | 0.005 | 59.4 | 63.8 | 46.5 |
| Example 9-2 | | (49) | (III) | 0.01 | 78.6 | 87.1 | 53.8 |
| Example 9-3 | | | | 0.1 | 88.8 | 90.5 | 73.8 |
| Example 9-4 | | | | 0.5 | 87.4 | 91.3 | 76.8 |
| Example 9-5 | | | | 1 | 86.9 | 90.8 | 73.9 |
| Example 9-6 | | | | 5 | 73.5 | 83.5 | 52.4 |
| Example 9-7 | | | | 10 | 48.3 | 53.2 | 40.6 |
| Example 10-1 | Graphite | Formula | Formula | 0.005 | 57.6 | 67.3 | 45.6 |
| Example 10-2 | | (50) | (III) | 0.01 | 79.6 | 86.9 | 53.6 |
| Example 10-3 | | | | 0.1 | 89.5 | 92.4 | 73.4 |
| Example 10-4 | | | | 0.5 | 90.0 | 91.9 | 77.0 |
| Example 10-5 | | | | 1 | 89.6 | 92.8 | 76.3 |
| Example 10-6 | | | | 5 | 74.3 | 85.3 | 51.2 |
| Example 10-7 | | | | 10 | 48.6 | 54.3 | 37.3 |
| Example 11-1 | Graphite | Formula | Formula | 0.005 | 58.3 | 63.9 | 40.8 |
| Example 11-2 | | (51) | (I) | 0.01 | 78.9 | 87.1 | 56.2 |
| Example 11-3 | | | | 0.1 | 87.9 | 93.1 | 76.3 |
| Example 11-4 | | | | 0.5 | 86.8 | 93.8 | 78.6 |
| Example 11-5 | | | | 1 | 88.3 | 93.6 | 78.3 |
| Example 11-6 | | | | 5 | 75.9 | 84.1 | 53.5 |
| Example 11-7 | | | | 10 | 50.5 | 56.4 | 34.7 |
| Comparative | Graphite | — | — | — | 40.2 | 48.2 | 31.5 |
| Example 1-1 | | | | | | | |
| Comparative | | Formula | — | 1 | 54.5 | 61.7 | 33.5 |
| Example 1-2 | | (52) | | | | | |
| Comparative | | Formula | — | 1 | 56.1 | 63.4 | 35.1 |
| Example 1-3 | | (53) | | | | | |
| Comparative | | Formula | — | 1 | 56.5 | 62.5 | 35.1 |
| Example 1-4 | | (54) | | | | | |
| Comparative | | Formula | — | 1 | 60.8 | 65.8 | 42.5 |
| Example 1-5 | | (55) | | | | | |
| Comparative | | Formula | — | 1 | 42.1 | 45.1 | 27.6 |
| Example 1-6 | | (56) | | | | | |
| Comparative | | Formula | — | 1 | 41.9 | 44.0 | 26.4 |
| Example 1-7 | | (57) | | | | | |

Tables 3 presents the evaluation results of the nonaqueous electrolytic secondary batteries in which the organophosphate compound was added in 1 mass % from among the nonaqueous electrolytic secondary batteries of Examples 7-1 to 11-7 and Comparative Examples 1-1 to 1-7.

TABLE 3

| | | Additive | | | | | |
|---|---|---|---|---|---|---|---|
| | | | | Amount | Percentage | Percentage | Percentage maintenance |
| | Negative | Structural | General | added | remaining | capacity | in high-temperature |
| | electrode | formula | formula | (mass %) | capacity (%) | recovery (%) | cycle (%) |
| Example 1-5 | Graphite | Formula | Formula | 1 | 88.0 | 90.8 | 74.5 |
| | | (41) | (II) | | | | |
| Example 2-5 | | Formula | Formula | 1 | 89.7 | 91.7 | 79.0 |
| | | (42) | (II) | | | | |
| Example 3-5 | | Formula | Formula | 1 | 88.9 | 91.5 | 73.9 |
| | | (43) | (II) | | | | |
| Example 4-5 | | Formula | Formula | 1 | 87.4 | 91.3 | 72.2 |
| | | (44) | (II) | | | | |
| Example 5-5 | | Formula | Formula | 1 | 88.3 | 91.5 | 71.1 |
| | | (45) | (II) | | | | |
| Example 6-5 | | Formula | Formula | 1 | 89.7 | 91.3 | 72.5 |
| | | (46) | (II) | | | | |
| Example 7-5 | | Formula | Formula | 1 | 67.1 | 70.1 | 53.7 |
| | | (47) | (II) | | | | |
| Example 8-5 | | Formula | Formula | 1 | 88.5 | 92.0 | 75.3 |
| | | (48) | (III) | | | | |
| Example 9-5 | | Formula | Formula | 1 | 86.9 | 90.8 | 73.9 |
| | | (49) | (III) | | | | |
| Example 10-5 | | Formula | Formula | 1 | 89.6 | 92.8 | 76.3 |
| | | (50) | (III) | | | | |
| Example 11-5 | | Formula | Formula | 1 | 88.3 | 93.6 | 78.3 |
| | | (51) | (I) | | | | |
| Comparative | Graphite | — | — | — | 40.2 | 48.2 | 31.5 |
| Example 1-1 | | | | | | | |
| Comparative | | Formula | — | 1 | 54.5 | 61.7 | 33.5 |
| Example 1-2 | | (52) | | | | | |
| Comparative | | Formula | — | 1 | 56.1 | 63.4 | 35.1 |
| Example 1-3 | | (53) | | | | | |
| Comparative | | Formula | — | 1 | 56.5 | 62.5 | 35.1 |
| Example 1-4 | | (54) | | | | | |
| Comparative | | Formula | — | 1 | 60.8 | 65.8 | 42.5 |
| Example 1-5 | | (55) | | | | | |
| Comparative | | Formula | — | 1 | 42.1 | 45.1 | 27.6 |
| Example 1-6 | | (56) | | | | | |
| Comparative | | Formula | — | 1 | 41.9 | 44.0 | 26.4 |
| Example 1-7 | | (57) | | | | | |

It can be seen from Table 3 that Examples 1-5, 2-5, . . . , 11-5 in which the organophosphate compounds of general formulae (I) to (III) were added to the electrolytic solution have improved high-temperature storage characteristics and improved high-temperature cycle characteristics compared to Comparative Example 1-1 in which the organophosphate compound was not added.

Comparative Examples 1-2 to 1-5 in which the organophosphate compounds not represented by general formulae (I) to (III) were added to the electrolytic solution had improved high-temperature storage characteristics and high-temperature cycle characteristics compared to Comparative Example 1-1 in which no organophosphate compound was added. However, the extent of improvement is smaller than in Examples 1-5, 2-5, . . . , 11-5.

Comparative Examples 1-6 and 1-7 in which the organophosphate compounds not represented by general formulae (I) to (III) were added to the electrolytic solution had high-temperature storage characteristics and high-temperature cycle characteristics lower than those obtained in Comparative Example 1-1 in which no organophosphate compound was added. Specifically, while there were slight improvements in percentage remaining capacity in Comparative Examples 1-6 and 1-7 over Comparative Example 1-1, percentage capacity recovery and percentage maintenance in high-temperature cycle were lower than those obtained in Comparative Example 1-1.

The differences in the effect of the different types of phosphorus compounds for improving the high-temperature characteristics are considered to be due to the structures of the organophosphate compounds used in Comparative Examples 1-1 to 1-7, as follows.

In Comparative Example 1-1, the organophosphate compound, as seen in structural formula (52), does not contain a substituent organic group having an unsaturated bond.

In Comparative Example 1-2, as seen in structural formula (53), there is no phosphorus-carbon (P—C) bond between the phosphorus and any of the substituents, and oxygen (—O—) is present between the phosphorus and carbon.

In Comparative Example 1-3, as seen in structural formula (54), the organic groups having an unsaturated bond are only aromatic groups.

In Comparative Example 1-4, as seen in structural formula (55), an organophosphate compound, specifically a cyclic phosphonic ester is used that is formed by the binding of the substituents, even though an unsaturated bond is present within the molecule.

In Comparative Example 1-5, as seen in structural formula (56), hydrogen is present that directly binds to the phosphorus.

In Comparative Example 1-6, as seen in structural formula (57), protonic hydrogen is present in the substituent binding to the phosphorus.

For the reasons described above, high-temperature storage characteristics and high-temperature cycle characteristics can be improved by adding the phosphine oxide, phosphonic ester, and phosphinic ester of general formulae (I) to (III) that have an unsaturated bond within the molecule. The effect of improving high-temperature storage characteristics and high-temperature cycle characteristics also can be expected with a combination of two or more of the phosphine oxide, phosphonic ester, and phosphinic ester.

It can be seen from Tables 1 and 2 that, in Examples 1-1 to 1-7 in which the organophosphate compound of structural formula (41) was added to the electrolytic solution, the extent of the effect of improving high-temperature storage characteristics and high-temperature cycle characteristics varies according to the amount of the organophosphate compound added. Specifically, while the high-temperature storage characteristics and high-temperature cycle characteristics improved with increasing amounts of the organophosphate compound from 0.005 mass % to 0.1 mass %, the high-temperature storage characteristics and high-temperature cycle characteristics had a tendency to deteriorate as the amount of the organophosphate compound was increased from 0.1 mass % to 10 mass %.

Thus, from the standpoint of improving high-temperature storage characteristics and high-temperature cycle characteristics, the addition amount of the organophosphate compound of structural formula (41) is preferably from 0.01 mass % to 5 mass %, more preferably 0.01 mass % to 1 mass %, further preferably 0.1 mass % to 1 mass %.

As in Examples 1-1 to 1-7, the extent of the effect of improving high-temperature storage characteristics and high-temperature cycle characteristics varies according to the amount of the organophosphate compound also in Examples 2-1 to 11-7 in which the organophosphate compounds of structural formula (42) to (51) were added to the electrolytic solution. Changes in the extent of these characteristics behave in substantially the same way as in Examples 1-1 to 1-7, and the addition amount preferably falls within the ranges specified in Examples 1-1 to 1-7.

Thus, from the standpoint of improving high-temperature storage characteristics and high-temperature cycle characteristics, the addition amount of the organophosphate compounds of general formulae (I) to (III) is preferably from 0.01 mass % to 5 mass %, more preferably 0.01 mass % to 1 mass %, further preferably 0.1 mass % to 1 mass %.

### Examples 12-1 to 22-7, Comparative Examples 2-1 to 2-7

Nonaqueous electrolytic secondary batteries were fabricated in the same manner as in Examples 1-1 to 11-7 and Comparative Examples 1-1 to 1-7, except that the negative electrode was fabricated by forming a silicon (Si) negative electrode active material layer on the both surfaces of a negative electrode collector realized by a copper foil (15 μm thick), using an electron beam vapor deposition method.

### Examples 23-1 to 33-7, Comparative Examples 3-1 to 3-7

A negative electrode was fabricated as follows. First, a tin (Sn).cobalt (Co).indium (In).fitanium (Ti) alloy powder, and a carbon (C) powder were mixed, and a SnCoC-containing material was synthesized using a mechanochemical reaction. By analysis, the composition of the SnCoC-containing material was found to be 48 mass % tin (Sn), 23 mass % cobalt (Co), and 20 mass % carbon (C). The proportion of cobalt (Co) in tin (Sn) and cobalt (Co) (Co/(Sn+Co)) was 32 mass %.

The SnCoC-containing material powder (negative electrode active material; 80 parts by mass), graphite (conductive agent; 12 parts by mass), and polyvinylidene fluoride (binder; 8 parts by mass) were mixed, and dispersed in the solvent N-methyl-2-pyrrolidone. The dispersion was then applied to a negative electrode collector realized by a copper foil (15 μm thick). After drying, a negative electrode active material layer was formed by compression molding.

Nonaqueous electrolytic secondary batteries were fabricated in the same manner as in Examples 1-1 to 11-7 and Comparative Examples 1-1 to 1-7 except for these differences.

(Evaluation)

The nonaqueous electrolytic secondary batteries of Examples 12-1 to 22-7, Comparative Examples 2-1 to 2-7, Examples 23-1 to 33-7, and Comparative Examples 3-1 to 3-7 were evaluated for high-temperature characteristics in the same manner as in Examples 1-1 to 11-7 and Comparative Examples 1-1 to 1-7. The results are presented in Tables 4 to 9.

Table 4 presents the evaluation results of the nonaqueous electrolytic secondary batteries of Examples 12-1 to 17-7.

TABLE 4

| | | Additive | | | | | |
|---|---|---|---|---|---|---|---|
| | | | | Amount | Percentage | Percentage | Percentage maintenance |
| | Negative | Structural | General | added | remaining | capacity | in high-temperature |
| | electrode | formula | formula | (mass %) | capacity (%) | recovery (%) | cycle (%) |
| Example 12-1 | Si | Formula | Formula | 0.005 | 47.6 | 57.3 | 39.5 |
| Example 12-2 | | (41) | (II) | 0.01 | 62.9 | 71.5 | 47.9 |
| Example 12-3 | | | | 0.1 | 73.1 | 77.2 | 65.2 |
| Example 12-4 | | | | 0.5 | 72.0 | 77.1 | 68.0 |
| Example 12-5 | | | | 1 | 72.6 | 75.6 | 67.4 |
| Example 12-6 | | | | 5 | 60.4 | 68.5 | 46.4 |
| Example 12-7 | | | | 10 | 43.9 | 59.4 | 38.1 |
| Example 13-1 | Si | Formula | Formula | 0.005 | 51.6 | 57.8 | 41.5 |
| Example 13-2 | | (42) | (II) | 0.01 | 65.8 | 72.3 | 49.8 |
| Example 13-3 | | | | 0.1 | 73.4 | 76.9 | 68.6 |
| Example 13-4 | | | | 0.5 | 72.8 | 78.1 | 72.1 |
| Example 13-5 | | | | 1 | 76.2 | 76.8 | 72.0 |
| Example 13-6 | | | | 5 | 72.4 | 67.9 | 46.6 |
| Example 13-7 | | | | 10 | 43.6 | 58.2 | 41.9 |
| Example 14-1 | Si | Formula | Formula | 0.005 | 46.6 | 53.4 | 41.1 |
| Example 14-2 | | (43) | (II) | 0.01 | 64.1 | 71.6 | 47.8 |
| Example 14-3 | | | | 0.1 | 71.5 | 76.8 | 63.9 |
| Example 14-4 | | | | 0.5 | 73.5 | 77.1 | 67.4 |
| Example 14-5 | | | | 1 | 74.1 | 76.5 | 68.7 |
| Example 14-6 | | | | 5 | 61.5 | 66.6 | 47.2 |
| Example 14-7 | | | | 10 | 44.0 | 58.4 | 38.6 |
| Example 15-1 | Si | Formula | Formula | 0.005 | 50.3 | 55.2 | 37.3 |
| Example 15-2 | | (44) | (II) | 0.01 | 64.8 | 72.4 | 45.6 |
| Example 15-3 | | | | 0.1 | 73.3 | 76.9 | 63.1 |
| Example 15-4 | | | | 0.5 | 74.5 | 77.3 | 64.2 |
| Example 15-5 | | | | 1 | 71.6 | 76.8 | 65.2 |
| Example 15-6 | | | | 5 | 67.5 | 65.5 | 42.7 |
| Example 15-7 | | | | 10 | 39.9 | 44.4 | 38.6 |
| Example 16-1 | Si | Formula | Formula | 0.005 | 49.7 | 54.6 | 43.8 |
| Example 16-2 | | (45) | (II) | 0.01 | 65.3 | 74.6 | 49.0 |
| Example 16-3 | | | | 0.1 | 71.8 | 79.0 | 63.6 |
| Example 16-4 | | | | 0.5 | 72.3 | 78.5 | 63.7 |
| Example 16-5 | | | | 1 | 74.0 | 75.4 | 64.3 |
| Example 16-6 | | | | 5 | 68.2 | 65.9 | 45.3 |
| Example 16-7 | | | | 10 | 43.6 | 56.8 | 41.7 |
| Example 17-1 | Si | Formula | Formula | 0.005 | 54.1 | 57.4 | 42.7 |
| Example 17-2 | | (46) | (II) | 0.01 | 65.8 | 75.5 | 50.1 |
| Example 17-3 | | | | 0.1 | 76.5 | 78.1 | 63.2 |
| Example 17-4 | | | | 0.5 | 75.4 | 78.3 | 64.9 |
| Example 17-5 | | | | 1 | 76.2 | 75.8 | 65.1 |
| Example 17-6 | | | | 5 | 61.3 | 67.3 | 46.4 |
| Example 17-7 | | | | 10 | 54.9 | 58.4 | 42.0 |

Table 5 presents the evaluation results of the nonaqueous electrolytic secondary batteries of Examples 18-1 to 22-7 and Comparative Examples 2-1 to 2-7.

TABLE 5

| | | Additive | | | | | |
|---|---|---|---|---|---|---|---|
| | | | | Amount | Percentage | Percentage | Percentage maintenance |
| | Negative | Structural | General | added | remaining | capacity | in high-temperature |
| | electrode | formula | formula | (mass %) | capacity (%) | recovery (%) | cycle (%) |
| Example 18-1 | Si | Formula | Formula | 0.005 | 41.6 | 63.6 | 35.1 |
| Example 18-2 | | (47) | (II) | 0.01 | 51.1 | 52.8 | 37.4 |
| Example 18-3 | | | | 0.1 | 55.6 | 68.4 | 41.4 |
| Example 18-4 | | | | 0.5 | 55.9 | 68.5 | 42.2 |
| Example 18-5 | | | | 1 | 51.7 | 55.1 | 39.7 |
| Example 18-6 | | | | 5 | 46.0 | 50.8 | 37.2 |
| Example 18-7 | | | | 10 | 43.3 | 44.4 | 34.6 |
| Example 19-1 | Si | Formula | Formula | 0.005 | 46.6 | 54.2 | 41.7 |
| Example 19-2 | | (48) | (III) | 0.01 | 63.1 | 71.6 | 47.2 |
| Example 19-3 | | | | 0.1 | 74.2 | 77.4 | 67.6 |
| Example 19-4 | | | | 0.5 | 73.6 | 76.1 | 67.5 |
| Example 19-5 | | | | 1 | 73.8 | 76.0 | 68.3 |
| Example 19-6 | | | | 5 | 61.0 | 68.2 | 47.5 |
| Example 19-7 | | | | 10 | 49.1 | 53.1 | 47.0 |
| Example 20-1 | Si | Formula | Formula | 0.005 | 48.3 | 52.9 | 43.5 |
| Example 20-2 | | (49) | (III) | 0.01 | 61.6 | 72.6 | 47.6 |
| Example 20-3 | | | | 0.1 | 73.2 | 75.8 | 67.8 |
| Example 20-4 | | | | 0.5 | 72.4 | 76.3 | 69.6 |
| Example 20-5 | | | | 1 | 73.5 | 76.0 | 67.2 |
| Example 20-6 | | | | 5 | 58.4 | 77.7 | 49.3 |
| Example 20-7 | | | | 10 | 47.0 | 52.1 | 41.9 |
| Example 21-1 | Si | Formula | Formula | 0.005 | 46.1 | 56.4 | 42.4 |
| Example 21-2 | | (50) | (III) | 0.01 | 64.5 | 71.3 | 47.5 |
| Example 21-3 | | | | 0.1 | 75.0 | 77.5 | 67.3 |
| Example 21-4 | | | | 0.5 | 76.1 | 77.0 | 70.0 |
| Example 21-5 | | | | 1 | 74.3 | 77.2 | 69.8 |
| Example 21-6 | | | | 5 | 59.9 | 70.1 | 48.7 |
| Example 21-7 | | | | 10 | 46.8 | 60.7 | 39.6 |
| Example 22-1 | Si | Formula | Formula | 0.005 | 47.6 | 52.6 | 37.8 |
| Example 22-2 | | (51) | (I) | 0.01 | 63.2 | 55.9 | 49.2 |
| Example 22-3 | | | | 0.1 | 72.4 | 78.4 | 69.3 |
| Example 22-4 | | | | 0.5 | 72.1 | 78.3 | 71.5 |
| Example 22-5 | | | | 1 | 73.3 | 78.6 | 71.4 |
| Example 22-6 | | | | 5 | 61.7 | 68.7 | 51.4 |
| Example 22-7 | | | | 10 | 48.5 | 64.4 | 36.7 |
| Comparative | Si | — | — | — | 33.2 | 40.6 | 22.6 |
| Example 2-1 | | | | | | | |
| Comparative | | Formula | — | 1 | 37.4 | 44.7 | 25.6 |
| Example 2-2 | | (52) | | | | | |
| Comparative | | Formula | — | 1 | 39.3 | 46.4 | 26.1 |
| Example 2-3 | | (53) | | | | | |
| Comparative | | Formula | — | 1 | 40.0 | 45.5 | 26.3 |
| Example 2-4 | | (54) | | | | | |
| Comparative | | Formula | — | 1 | 43.8 | 48.1 | 23.5 |
| Example 2-5 | | (55) | | | | | |
| Comparative | | Formula | — | 1 | 25.6 | 28.4 | 20.6 |
| Example 2-6 | | (56) | | | | | |
| Comparative | | Formula | — | 1 | 23.7 | 27.0 | 19.4 |
| Example 2-7 | | (57) | | | | | |

Table 6 presents the evaluation results of the nonaqueous electrolytic secondary batteries in which the organophosphate compound was added in 1 mass % from among the nonaqueous electrolytic secondary batteries of Examples 12-1 to 22-7 and Comparative Examples 2-1 to 2-7.

TABLE 6

| | | Additive | | | | | |
|---|---|---|---|---|---|---|---|
| | | | | Amount | Percentage | Percentage | Percentage maintenance |
| | Negative | Structural | General | added | remaining | capacity | in high-temperature |
| | electrode | formula | formula | (mass %) | capacity (%) | recovery (%) | cycle (%) |
| Example 12-5 | Si | Formula | Formula | 1 | 72.6 | 75.6 | 67.4 |
| | | (41) | (II) | | | | |
| Example 13-5 | | Formula | Formula | 1 | 76.2 | 76.8 | 72.0 |
| | | (42) | (II) | | | | |
| Example 14-5 | | Formula | Formula | 1 | 74.1 | 76.5 | 68.7 |
| | | (43) | (II) | | | | |
| Example 15-5 | | Formula | Formula | 1 | 71.6 | 76.8 | 65.2 |
| | | (44) | (II) | | | | |
| Example 16-5 | | Formula | Formula | 1 | 74.0 | 75.4 | 64.3 |
| | | (45) | (II) | | | | |
| Example 17-5 | | Formula | Formula | 1 | 76.2 | 75.8 | 65.1 |
| | | (46) | (II) | | | | |
| Example 18-5 | | Formula | Formula | 1 | 51.7 | 55.1 | 39.7 |
| | | (47) | (II) | | | | |
| Example 19-5 | | Formula | Formula | 1 | 73.8 | 76.0 | 68.3 |
| | | (48) | (III) | | | | |
| Example 20-5 | | Formula | Formula | 1 | 73.5 | 76.0 | 67.2 |
| | | (49) | (III) | | | | |
| Example 21-5 | | Formula | Formula | 1 | 74.3 | 77.2 | 69.8 |
| | | (50) | (III) | | | | |
| Example 22-5 | | Formula | Formula | 1 | 73.3 | 78.6 | 71.4 |
| | | (51) | (I) | | | | |
| Comparative | Si | — | — | — | 33.2 | 40.6 | 22.6 |
| Example 2-1 | | | | | | | |
| Comparative | | Formula | — | 1 | 37.4 | 44.7 | 25.6 |
| Example 2-2 | | (52) | | | | | |
| Comparative | | Formula | — | 1 | 39.3 | 46.4 | 26.1 |
| Example 2-3 | | (53) | | | | | |
| Comparative | | Formula | — | 1 | 40.0 | 45.5 | 26.3 |
| Example 2-4 | | (54) | | | | | |
| Comparative | | Formula | — | 1 | 43.8 | 48.1 | 23.5 |
| Example 2-5 | | (55) | | | | | |
| Comparative | | Formula | — | 1 | 25.6 | 28.4 | 20.6 |
| Example 2-6 | | (56) | | | | | |
| Comparative | | Formula | — | 1 | 23.7 | 27.0 | 19.4 |
| Example 2-7 | | (57) | | | | | |

Table 7 presents the evaluation results of the nonaqueous electrolytic secondary batteries of Examples 23-1 to 28-7.

TABLE 7

| | | Additive | | | | | |
|---|---|---|---|---|---|---|---|
| | | | | Amount | Percentage | Percentage | Percentage maintenance |
| | Negative | Structural | General | added | remaining | capacity | in high-temperature |
| | electrode | formula | formula | (mass %) | capacity (%) | recovery (%) | cycle (%) |
| Example 23-1 | SnCoC | Formula | Formula | 0.005 | 52.6 | 57.3 | 41.6 |
| Example 23-2 | | (41) | (II) | 0.01 | 68.4 | 76.4 | 49.5 |
| Example 23-3 | | | | 0.1 | 77.6 | 82.3 | 67.8 |
| Example 23-4 | | | | 0.5 | 76.5 | 82.0 | 70.0 |
| Example 23-5 | | | | 1 | 78.0 | 80.5 | 69.8 |
| Example 23-6 | | | | 5 | 65.4 | 73.5 | 48.3 |
| Example 23-7 | | | | 10 | 49.2 | 54.6 | 40.2 |
| Example 24-1 | SnCoC | Formula | Formula | 0.005 | 58.6 | 62.7 | 42.8 |
| Example 24-2 | | (42) | (II) | 0.01 | 70.1 | 77.6 | 51.4 |
| Example 24-3 | | | | 0.1 | 78.6 | 82.3 | 70.6 |
| Example 24-4 | | | | 0.5 | 78.5 | 83.1 | 74.3 |
| Example 24-5 | | | | 1 | 79.4 | 80.9 | 74.2 |
| Example 24-6 | | | | 5 | 70.3 | 72.6 | 48.3 |
| Example 24-7 | | | | 10 | 48.2 | 54.0 | 41.8 |
| Example 25-1 | SnCoC | Formula | Formula | 0.005 | 50.9 | 56.9 | 42.1 |
| Example 25-2 | | (43) | (II) | 0.01 | 68.0 | 76.8 | 49.3 |
| Example 25-3 | | | | 0.1 | 76.5 | 81.5 | 66.2 |
| Example 25-4 | | | | 0.5 | 78.2 | 82.6 | 68.5 |
| Example 25-5 | | | | 1 | 78.4 | 81.3 | 68.9 |
| Example 25-6 | | | | 5 | 66.3 | 71.2 | 50.4 |
| Example 25-7 | | | | 10 | 48.5 | 53.6 | 40.8 |
| Example 26-1 | SnCoC | Formula | Formula | 0.005 | 55.0 | 60.3 | 40.5 |
| Example 26-2 | | (44) | (II) | 0.01 | 70.1 | 77.4 | 47.5 |
| Example 26-3 | | | | 0.1 | 78.6 | 82.0 | 65.3 |
| Example 26-4 | | | | 0.5 | 79.5 | 82.4 | 66.8 |
| Example 26-5 | | | | 1 | 77.4 | 81.6 | 67.4 |
| Example 26-6 | | | | 5 | 63.6 | 70.7 | 44.2 |
| Example 26-7 | | | | 10 | 48.9 | 52.8 | 40.6 |
| Example 27-1 | SnCoC | Formula | Formula | 0.005 | 55.4 | 59.6 | 45.5 |
| Example 27-2 | | (45) | (II) | 0.01 | 70.1 | 79.4 | 51.0 |
| Example 27-3 | | | | 0.1 | 77.5 | 83.5 | 65.4 |
| Example 27-4 | | | | 0.5 | 78.6 | 82.1 | 66.8 |
| Example 27-5 | | | | 1 | 78.1 | 81.8 | 66.1 |
| Example 27-6 | | | | 5 | 64.5 | 70.6 | 47.2 |
| Example 27-7 | | | | 10 | 48.8 | 53.0 | 43.9 |
| Example 28-1 | SnCoC | Formula | Formula | 0.005 | 58.3 | 62.6 | 44.8 |
| Example 28-2 | | (46) | (II) | 0.01 | 70.8 | 80.5 | 52.0 |
| Example 28-3 | | | | 0.1 | 79.6 | 83.6 | 65.3 |
| Example 28-4 | | | | 0.5 | 80.1 | 83.4 | 67.1 |
| Example 28-5 | | | | 1 | 79.9 | 81.2 | 67.5 |
| Example 28-6 | | | | 5 | 65.6 | 72.9 | 54.0 |
| Example 28-7 | | | | 10 | 51.1 | 53.3 | 48.4 |

Table 8 presents the evaluation results of the nonaqueous electrolytic secondary batteries of Examples 29-1 to 33-7 and Comparative Examples 3-1 to 3-7.

TABLE 8

| | | Additive | | | | | |
|---|---|---|---|---|---|---|---|
| | | | | Amount | Percentage | Percentage | Percentage maintenance |
| | Negative | Structural | General | added | remaining | capacity | in high-temperature |
| | electrode | formula | formula | (mass %) | capacity (%) | recovery (%) | cycle (%) |
| Example 29-1 | SnCoC | Formula | Formula | 0.005 | 46.6 | 48.2 | 32.1 |
| Example 29-2 | | (47) | (II) | 0.01 | 55.4 | 57.6 | 38.5 |
| Example 29-3 | | | | 0.1 | 60.1 | 63.5 | 43.2 |
| Example 29-4 | | | | 0.5 | 61.2 | 63.8 | 44.6 |
| Example 29-5 | | | | 1 | 57.6 | 60.3 | 41.7 |
| Example 29-6 | | | | 5 | 51.3 | 55.6 | 41.2 |
| Example 29-7 | | | | 10 | 46.3 | 49.6 | 36.9 |
| Example 30-1 | SnCoC | Formula | Formula | 0.005 | 51.5 | 59.3 | 43.7 |
| Example 30-2 | | (48) | (III) | 0.01 | 69.1 | 76.3 | 49.3 |
| Example 30-3 | | | | 0.1 | 77.7 | 81.5 | 68.3 |
| Example 30-4 | | | | 0.5 | 76.9 | 82.1 | 71.6 |
| Example 30-5 | | | | 1 | 78.5 | 82.0 | 70.3 |
| Example 30-6 | | | | 5 | 65.3 | 74.3 | 49.6 |
| Example 30-7 | | | | 10 | 48.8 | 54.0 | 39.9 |
| Example 31-1 | SnCoC | Formula | Formula | 0.005 | 53.5 | 57.6 | 45.5 |
| Example 31-2 | | (49) | (III) | 0.01 | 68.6 | 77.3 | 48.8 |
| Example 31-3 | | | | 0.1 | 78.8 | 80.5 | 68.6 |
| Example 31-4 | | | | 0.5 | 77.6 | 81.6 | 71.5 |
| Example 31-5 | | | | 1 | 76.9 | 80.2 | 68.3 |
| Example 31-6 | | | | 5 | 63.5 | 72.9 | 51.6 |
| Example 31-7 | | | | 10 | 57.6 | 52.1 | 44.7 |
| Example 32-1 | SnCoC | Formula | Formula | 0.005 | 51.6 | 61.6 | 44.6 |
| Example 32-2 | | (50) | (III) | 0.01 | 69.5 | 76.5 | 48.5 |
| Example 32-3 | | | | 0.1 | 79.6 | 82.1 | 68.8 |
| Example 32-4 | | | | 0.5 | 80.0 | 81.9 | 72.0 |
| Example 32-5 | | | | 1 | 79.6 | 83.0 | 71.3 |
| Example 32-6 | | | | 5 | 64.5 | 75.3 | 50.2 |
| Example 32-7 | | | | 10 | 47.9 | 53.7 | 41.3 |
| Example 33-1 | SnCoC | Formula | Formula | 0.005 | 52.5 | 57.6 | 39.9 |
| Example 33-2 | | (51) | (I) | 0.01 | 68.5 | 61.3 | 51.3 |
| Example 33-3 | | | | 0.1 | 77.4 | 83.2 | 71.4 |
| Example 33-4 | | | | 0.5 | 76.2 | 83.8 | 73.2 |
| Example 33-5 | | | | 1 | 78.7 | 82.9 | 73.0 |
| Example 33-6 | | | | 5 | 65.9 | 74.6 | 52.6 |
| Example 33-7 | | | | 10 | 49.7 | 55.4 | 38.4 |
| Comparative | SnCoC | — | — | — | 37.3 | 43.3 | 26.7 |
| Example 3-1 | | | | | | | |
| Comparative | | Formula | — | 1 | 41.6 | 46.7 | 28.4 |
| Example 3-2 | | (52) | | | | | |
| Comparative | | Formula | — | 1 | 43.2 | 48.4 | 30.1 |
| Example 3-3 | | (53) | | | | | |
| Comparative | | Formula | — | 1 | 43.3 | 47.6 | 30.5 |
| Example 3-4 | | (54) | | | | | |
| Comparative | | Formula | — | 1 | 43.8 | 46.6 | 32.6 |
| Example 3-5 | | (55) | | | | | |
| Comparative | | Formula | — | 1 | 29.5 | 30.1 | 22.1 |
| Example 3-6 | | (56) | | | | | |
| Comparative | | Formula | — | 1 | 28.9 | 29.9 | 21.5 |
| Example 3-7 | | (57) | | | | | |

Table 9 presents the evaluation results of the nonaqueous electrolytic secondary batteries in which the organophosphate compound was added in 1 mass % from among the nonaqueous electrolytic secondary batteries of Examples 23-1 to 33-7 and Comparative Examples 3-1 to 3-7.

TABLE 9

| | | Additive | | | | | |
|---|---|---|---|---|---|---|---|
| | | | | Amount | Percentage | Percentage | Percentage maintenance |
| | Negative | Structural | General | added | remaining | capacity | in high-temperature |
| | electrode | formula | formula | (mass %) | capacity (%) | recovery (%) | cycle (%) |
| Example 23-5 | SnCoC | Formula | Formula | 1 | 78.0 | 80.5 | 69.8 |
| | | (41) | (II) | | | | |
| Example 24-5 | | Formula | Formula | 1 | 79.4 | 80.9 | 74.2 |
| | | (42) | (II) | | | | |
| Example 25-5 | | Formula | Formula | 1 | 78.4 | 81.3 | 68.9 |
| | | (43) | (II) | | | | |
| Example 26-5 | | Formula | Formula | 1 | 77.4 | 81.6 | 67.4 |
| | | (44) | (II) | | | | |
| Example 27-5 | | Formula | Formula | 1 | 78.1 | 81.8 | 66.1 |
| | | (45) | (II) | | | | |
| Example 28-5 | | Formula | Formula | 1 | 79.9 | 81.2 | 67.5 |
| | | (46) | (II) | | | | |
| Example 29-5 | | Formula | Formula | 1 | 57.6 | 60.3 | 41.7 |
| | | (47) | (II) | | | | |
| Example 30-5 | | Formula | Formula | 1 | 78.5 | 82.0 | 70.3 |
| | | (48) | (III) | | | | |
| Example 31-5 | | Formula | Formula | 1 | 76.9 | 80.2 | 68.3 |
| | | (49) | (III) | | | | |
| Example 32-5 | | Formula | Formula | 1 | 79.6 | 83.0 | 71.3 |
| | | (50) | (III) | | | | |
| Example 33-5 | | Formula | Formula | 1 | 78.7 | 82.9 | 73.0 |
| | | (51) | (I) | | | | |
| Comparative | SnCoC | — | — | — | 37.3 | 43.3 | 26.7 |
| Example 3-1 | | | | | | | |
| Comparative | | Formula | — | 1 | 41.6 | 46.7 | 28.4 |
| Example 3-2 | | (52) | | | | | |
| Comparative | | Formula | — | 1 | 43.2 | 48.4 | 30.1 |
| Example 3-3 | | (53) | | | | | |
| Comparative | | Formula | — | 1 | 43.3 | 47.6 | 30.5 |
| Example 3-4 | | (54) | | | | | |
| Comparative | | Formula | — | 1 | 43.8 | 46.6 | 32.6 |
| Example 3-5 | | (55) | | | | | |
| Comparative | | Formula | — | 1 | 29.5 | 30.1 | 22.1 |
| Example 3-6 | | (56) | | | | | |
| Comparative | | Formula | — | 1 | 28.9 | 29.9 | 21.5 |
| Example 3-7 | | (57) | | | | | |

It can be seen from Tables 6 and 9 that high-temperature storage characteristics and high-temperature cycle characteristics can be improved also in the nonaqueous electrolytic secondary batteries that use Si and SnCoC-containing material as the negative electrode material, provided that one of the phosphine oxide, phosphonic ester, and phosphinic ester of general formulae (I) to (III) that contain an unsaturated bond within the molecule is added. The effect is exhibited regardless of the type of the negative electrode material. The effect of improving high-temperature storage characteristics and high-temperature cycle characteristics also can be expected with a combination of two or more of the phosphine oxide, phosphonic ester, and phosphinic ester. Further, the effect of improving high-temperature storage characteristics and high-temperature cycle characteristics also can be expected even when metals other than Si, and alloys other than the SnCoC-containing material are used as the negative electrode material.

On the other hand, high-temperature characteristics do not improve as much when the phosphorus compound does not have an unsaturated bond within the molecule, or when the phosphorus compound has a hydrogen atom that directly binds to the phosphorus atom, or has a protonic hydrogen atom in the substituent binding to the phosphorus atom. Further, a sufficient effect cannot be obtained with a cyclic phosphonic ester, even when an unsaturated bond is present within the molecule. It can be said from this that the characteristic improving effect is specific to the phosphine oxide, phosphonic ester, and phosphinic ester that have an unsaturated bond within the molecule.

It can be seen from Tables 4, 5, 7, and 8 that, from the standpoint of improving high-temperature storage characteristics and high-temperature cycle characteristics, the organophosphate compounds of general formulae (I) to (III) are added in preferably 0.01 mass % to 5 mass %, more preferably 0.01 mass % to 1 mass %, further preferably 0.1 mass % to 1 mass %.

While the present application has been described with respect to certain embodiments, the present application is not limited by these embodiments, and various modifications are possible based on the technical ideas of the present application.

For example, the configurations, methods, steps, shapes, materials, and numerical values described in the foregoing embodiments are merely examples, and different configurations, methods, steps, shapes, materials, and numerical values may be used, as required.

Further, for example, the configurations, methods, steps, shapes, materials, and numerical values described in the foregoing embodiments may be combined, provided that such changes are within the gist of the present application.

Further, while the foregoing embodiments described the present application based on the battery of a wound structure, the battery structure is not limited to this specific example. For example, the present application is also applicable to batteries of other structures, including a structure with folded or laminated positive and negative electrodes.

Further, while the foregoing embodiments described the present application based on the cylindrical or flat battery, the battery shape is not limited to this specific example. For example, the present application is also applicable to batteries of other shapes, including coin-shaped, button-shaped, and rectangular batteries.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A nonaqueous electrolytic secondary battery comprising:
a positive electrode;
a negative electrode; and
an electrolyte that contains a nonaqueous electrolytic solution,
wherein the nonaqueous electrolytic solution contains at least one phosphorus compound selected from the group consisting of phosphine oxide, phosphonic ester, and phosphinic ester, and the phosphine oxide, the phosphonic ester, and the phosphinic ester are phosphorus compounds represented by the following formulae (I), (II), and (III), respectively, 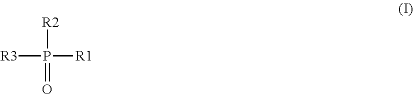
wherein R1 is an organic group having one or more unsaturated bonds, and the phosphorus and R1 are bonded to each other by a phosphorus-carbon (P—C) bond, wherein R2 and R3 each independently represent a hydrocarbon group of 1 to 20 carbon atoms, or a hydrocarbon group of 1 to 20 carbon atoms whose hydrogen atoms are at least partially replaced with a halogen atom, and wherein R1, R2, and R3 are unbound to each other, 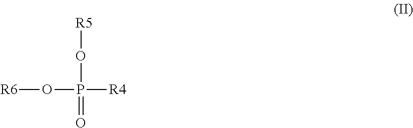
wherein R4 is an organic group having one or more unsaturated bonds, and the phosphorus and R4 are bonded to each other by a phosphorus-carbon (P—C) bond, wherein R5 and R6 each independently represent a hydrocarbon group of 1 to 20 carbon atoms, or a hydrocarbon group of 1 to 20 carbon atoms whose halogen atoms are at least partially replaced with a halogen atom, and wherein R4, R5, and R6 are unbound to each other, 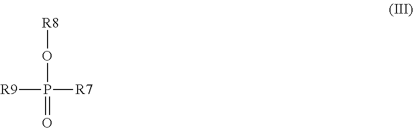
wherein R7 is an organic group having one or more unsaturated bonds, and the phosphorus and R7 are bonded to each other by a phosphorus-carbon (P—C) bond, wherein R8 and R9 each independently represent a hydrocarbon group of 1 to 20 carbon atoms, or a hydrocarbon group of 1 to 20 carbon atoms whose halogen atoms are at least partially replaced with a halogen atom, and wherein R7, R8, and R9 are unbound to each other.

2. The nonaqueous electrolytic secondary battery according to claim 1, wherein the unsaturated bonds in the organic groups R1, R4, and R7 are carbon-carbon unsaturated bonds.

3. The nonaqueous electrolytic secondary battery according to claim 2, wherein the organic groups R1, R4, and R7 are each an unsaturated hydrocarbon group, or an unsaturated hydrocarbon group partially replaced with a substituent.

4. The nonaqueous electrolytic secondary battery according to claim 3, wherein the unsaturated hydrocarbon group is an alkenyl group, an alkadienyl group, an alkynyl group, or an alkydienyl group.

5. The nonaqueous electrolytic secondary battery according to claim 3, wherein the substituent is at least one selected from the group consisting of a halogen atom, an oxy group, an epoxy group, a carbonyl group, an ester group, a nitrile group, a carbonate group, a sulfide group, a sulfinyl group, a sulfonyl group, a sulfonyloxy group, an alkenyl group, an alkynyl group, a phenyl group, a phenylene group, an aralkyl group, and one of these groups whose hydrogen atoms are at least partially replaced with a halogen atom.

6. The nonaqueous electrolytic secondary battery according to claim 3, wherein the number of carbon atoms in the organic groups R1, R4, and R7 is from 2 to 20.

7. The nonaqueous electrolytic secondary battery according to claim 1, wherein the content of the phosphorus compound with respect to the nonaqueous electrolytic solution is from 0.01 mass % to 5 mass %.

8. The nonaqueous electrolytic secondary battery according to claim 1, wherein the nonaqueous electrolytic solution contains at least one compound selected from the group consisting of unsaturated carbonate esters and halogenated carbonate esters.

9. The nonaqueous electrolytic secondary battery according to claim 1, wherein at least one of the positive electrode and the negative electrode has a surface with a coating that originates in the phosphorus compound.

10. A nonaqueous electrolytic solution comprising:
at least one phosphorus compound selected from the group consisting of phosphine oxide, phosphonic ester, and phosphinic ester,
wherein the phosphine oxide, the phosphonic ester, and the phosphinic ester are phosphorus compounds represented by the following formulae (I), (II), and (III), respectively, 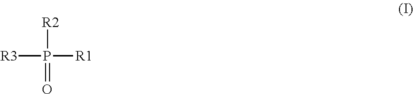
wherein R1 is an organic group having one or more unsaturated bonds, and the phosphorus and R1 are bonded to each other by a phosphorus-carbon (P—C) bond, wherein R2 and R3 each independently represent a hydrocarbon group of 1 to 20 carbon atoms, or a hydrocarbon group of 1 to 20 carbon atoms whose halogen atoms are at least partially replaced with a halogen atom, and wherein R1, R2, and R3 are unbound to each other, 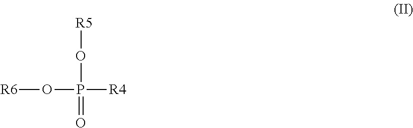
wherein R4 is an organic group having one or more unsaturated bonds, and the phosphorus and R4 are bonded to each other by a phosphorus-carbon (P—C) bond, wherein R5 and R6 each independently represent a hydrocarbon group of 1 to 20 carbon atoms, or a hydrocarbon group of 1 to 20 carbon atoms whose halogen atoms are at least partially replaced with a halogen atom, and wherein R4, R5, and R6 are unbound to each other, 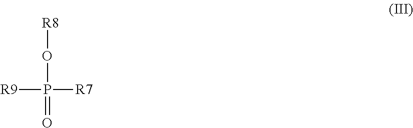
wherein R7 is an organic group having one or more unsaturated bonds, and the phosphorus and R7 are bonded to each other by a phosphorus-carbon (P—C) bond, wherein R8 and R9 each independently represent a hydrocarbon group of 1 to 20 carbon atoms, or a hydrocarbon group of 1 to 20 carbon atoms whose halogen atoms are at least partially replaced with a halogen atom, and wherein R7, R8, and R9 are unbound to each other.

11. A nonaqueous electrolytic secondary battery comprising:
a positive electrode;
a negative electrode; and
an electrolyte that contains a nonaqueous electrolytic solution,
wherein the nonaqueous electrolytic solution contains at least one phosphorus compound selected from the group consisting of phosphine oxide, phosphonic ester, and phosphinic ester, and the phosphorus compound has a substituent that contains one or more unsaturated bonds, and the substituent has a carbon atom attached to the phosphorus.

12. A nonaqueous electrolytic solution comprising:
at least one phosphorus compound selected from the group consisting of phosphine oxide, phosphonic ester, and phosphinic ester,
wherein the phosphorus compound has a substituent that contains one or more unsaturated bonds, and the substituent has a carbon atom attached to the phosphorus.

13. A battery pack comprising:
the nonaqueous electrolytic secondary battery of claim 1;
a controller that performs control for the nonaqueous electrolytic secondary battery; and
an exterior encasing the nonaqueous electrolytic secondary battery.

14. An electronic device comprising:
the nonaqueous electrolytic secondary battery of claim 1,
wherein the electronic device receives power from the nonaqueous electrolytic secondary battery.

15. An electric vehicle comprising:
the nonaqueous electrolytic secondary battery of claim 1;
a converter that receives power from the nonaqueous electrolytic secondary battery, and converts the received power into the driving power of the vehicle; and
a control unit that processes information concerning vehicle control based on information concerning the nonaqueous electrolytic secondary battery.

16. A power storage device comprising:
the nonaqueous electrolytic secondary battery of claim 1,
wherein the power storage device supplies power to an electronic device connected to the nonaqueous electrolytic secondary battery.

17. The power storage device according to claim 16, further comprising a power information control unit that transmits and receives a signal to and from another device via a network,
wherein the power storage device controls the charge and discharge of the nonaqueous electrolytic secondary battery based on the information received by the power information control unit.

18. A power system that receives power from the nonaqueous electrolytic secondary battery of claim 1, or that supplies power to the nonaqueous electrolytic secondary battery from a power generating unit or a power grid.
